(19) United States
(12) Patent Application Publication
(10) Pub. No.: US 2026/0324659 A1
(43) Pub. Date: Oct. 22, 2026

(54) SYSTEMS AND METHODS FOR CARRIER SYSTEMS FOR CONTROLLED RELEASE DELIVERY IN PERISHABLE GOODS

(71) Applicant: Ryp Labs, Inc., Bothell, WA (US)

(72) Inventors: Ahmed SOLIMAN, Kirkland, WA (US); Steven John HULTENG, Mukilteo, WA (US); Ozgur Emek YILDIRIM, Bellevue, WA (US); Benjamin Grady JONES, Issaquah, WA (US); Craig William GRAHAM, Anacortes, WA (US)

(73) Assignee: Ryp Labs, Inc., Bothell, WA (US)

(21) Appl. No.: 19/115,732

(22) PCT Filed: Sep. 29, 2023
(86) PCT No.: PCT/US2023/075495

§ 371 Date: Mar. 26, 2025

Related U.S. Application Data
(60) Provisional application No. 63/378,309, filed on Oct. 4, 2022.

(51) Int. Cl. A23B 2/708

(52) U.S. Cl. CPC A23B 2/708

(57) ABSTRACT

A transmission system for reducing decomposition of a perishable good, the system comprising one or more compositions, wherein the one or more compositions comprise at least one active compound, and at least one non-active compound, and at least one carrier configured to support the one or more compositions, wherein the at least one carrier comprises a release rate altering mechanism, wherein the release rate altering mechanism is configured to modulate the release rate of the one or more compositions.

### CROSS-REFERENCE TO RELATED APPLICATION

This application claims the benefit of U.S. Provisional Application 63/378,309, filed Oct. 4, 2022, the entire disclosure of which is hereby incorporated by reference.

### BACKGROUND

Various volatile compounds like essential oil compounds are known to have antifungal activity and can help extend shelf lives of perishable goods by inhibiting spoilage. Preventing spoilage over a certain duration of time requires that the compounds are released to the environment in a continuous and predictable manner so as to maintain the desired concentrations of the compounds in a gas phase. In addition to volatile compounds with antifungal activity, other volatile compounds, like 1-MCP as utilized in the environment of perishable goods like climacteric fruits, can act in tandem in order to extend the shelf life of perishable produce.

Accordingly, systems and methods for controlling the release rate of an active compound to prolong a shelf life of a perishable good are needed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The presently disclosed and/or claimed technology relates generally to one or more transmission systems for the delivery of one or more active compound to reduce the decomposition of perishable goods. The prevention of deterioration of the perishable good over a period of time requires that the one or more active compound be released in a continuous and predictable manner so as to maintain the desired concentration of the one or more active compound in the gas phase within the perishable good(s) environment.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A shows example compounds, in accordance with the present technology;

FIG. 1B is a graph of properties of the example compounds of FIG. 1A, in accordance with the present technology;

FIGS. 2A-2I are example carriers, in accordance with the present technology;

FIG. 3 is an example diffusion cell, in accordance with the present technology;

FIG. 4 is a test fixture, in accordance with the present technology;

FIG. 5 is a graph showing diffusion through an example membrane, in accordance with the present technology;

FIG. 6 is a graph showing diffusion through another example membrane, in accordance with the present technology;

FIG. 7 is a graph showing vapor pressure of wax carriers, in accordance with the present technology;

FIG. 8 is a graph showing vapor pressure of PP film carriers, in accordance with the present technology;

FIG. 9 shows the evolution over time of the vapor pressures measured in identically leaky containers, in accordance with the present technology;

FIG. 10 is an example geometry for a carrier used in the simulations, in accordance with the present technology;

FIG. 11 shows concentration distribution of volatiles in solid, rectangularly shaped-carrier matrices with varying diffusivities of volatiles inside the matrix, in accordance with the present technology;

FIG. 12 is a graph of different release profiles that would be observed in the box from the matrices of FIG. 11, in accordance with the present technology;

FIG. 13 shows concentration distribution of volatiles in different sized rectangular carriers, in accordance with the present technology;

FIG. 14 is a graph of different release profiles in the box from the differently sized matrices of FIG. 13, in accordance with the present technology;

FIG. 15 shows the construction of the carrier with multilayer construction, in accordance with the present technology;

FIG. 16 shows concentration distribution of volatiles in carriers with outer layers of varying diffusivities, but same thickness, in accordance with the present technology;

FIG. 17 is a graph of the different release profiles in the box from the carriers of FIG. 16, in accordance with the present technology;

FIG. 18 shows concentration distribution of volatiles in solid, rectangularly shaped-carrier matrices, in accordance with the present technology;

FIG. 19 is a graph of different release profiles in the box from the matrices of FIG. 18, in accordance with the present technology;

FIG. 20 shows concentration distribution of volatiles in different shapes, in accordance with the present technology;

FIG. 21 is a graph of different release profiles from the differently shaped matrices of FIG. 20, in accordance with the present technology;

FIG. 22 shows concentration distribution of volatiles in ball-shaped carriers, in accordance with the present technology; and

FIG. 23 is a graph of different release profiles into a container from the ball-shaped carriers of FIG. 22, in accordance with the present technology.

### DETAILED DESCRIPTION

While illustrative embodiments have been illustrated and described, it will be appreciated that various changes can be made therein without departing from the spirit and scope of the invention.

Before explaining at least one embodiment of the presently disclosed and/or claimed inventive concept(s) in detail, it is to be understood that the presently disclosed and/or claimed inventive concept(s) is not limited in its application to the details of construction and the arrangement of the components or steps or methodologies set forth in the following description. The presently disclosed and/or claimed inventive concept(s) is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the presently disclosed and/or claimed inventive concept(s) shall have the meanings that are commonly understood by those of ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the presently disclosed and/or claimed inventive concept(s) pertains. All patents, published patent applications, and non-patent publications referenced in any portion of this application are herein expressly incorporated by reference in their entirety to the same extent as if each individual patent or publication was specifically and individually indicated to be incorporated by reference.

All of the articles and/or methods disclosed herein can be made and executed without undue experimentation in light of the present disclosure. While the articles and methods of the presently disclosed and/or claimed inventive concept(s) have been described in terms of preferred embodiments, it will be apparent to those skilled in the art that variations may be applied to the articles and/or methods and in the steps or in the sequence of steps of the method described herein without departing from the concept, spirit, and scope of the presently disclosed and/or claimed inventive concept(s).

As utilized in accordance with the present disclosure, the following terms, unless otherwise indicated, shall be understood to have the following meanings.

The use of the word “a” or “an” when used in conjunction with the term “comprising” may mean “one”, but it is also consistent with the meaning of “one or more”, “at least one”, and “one or more than one”. The use of the term “or” is used to mean “and/or” unless explicitly indicated to refer to alternatives only if the alternatives are mutually exclusive, although the disclosure supports a definition that refers to only alternatives “and/or”. Throughout this application, the term “about” is used to indicate that a value includes the inherent variation of error for the quantifying device, the method being employed to determine the value, or the variation that exists among the study subjects. For example, but not by way of limitation, when the term “about” is utilized, the designation value may vary by plus or minus twelve percent, or eleven percent, or ten percent, or nine percent, or eight percent, or seven percent, or six percent, or five percent, or four percent, or three percent, or two percent, or one percent. The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as lower or higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first”, “second”, “third”, “fourth”, etc.) is solely for the purpose of differentiating between two or more items and is not meant to imply any sequence or order or importance to one item over another or any order of addition, for example.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. The term “or combinations thereof” as used herein refers to all permutations and combinations of the listed items preceding the term. For example, “A, B, C, or combinations thereof” is intended to include at least one of: A, B, C, AB, AC, BC, or ABC and, if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

Postharvest spoilage of fruits, vegetables and plants causes significant economic loss. Certain volatile essential oil compounds (also referred to as “bioactive compounds,” “compounds,” or “formulations”) possess bioactive properties that help protect perishable produce from spoilage. When these bioactive compounds are released into the environment where the perishable produce is stored, the post-harvest losses due to spoilage can be reduced. The formulations can include one or more such active compounds that suppress spoilage by limiting microbial growth. The formulations can also include compounds with other important functions such as those that preserve and stabilize the active compounds (such as antioxidants), compounds that help create a desirable aroma profile, those that can modulate the ethylene response, and those that stimulate and modulate the natural defenses/immune responses of the produce. Finally, such ingredients can also be combined with various carrier and controlled release matrices such as waxes. These formulations, or composite formulation-carrier combinations constitute a platform that perform the core functions affecting the biological response.

The inventive technology relates generally to transmission systems by which a composition having one or more active compound is delivered to the environment to reduce decomposition of perishable goods. Specifically, the one or more transmission system comprising a composition having one or more active compound, a carrier, and a release rate altering mechanism allows the one or more active compound to release into the surrounding environment in a controlled, predictable way.

One approach to introduce the active compounds to the environment is to rely on electromechanical-thermal-fluidic devices that can precisely dispense the compounds from a supply reservoir using a variety of delivery, injection, misting/atomization/nebulization or similar technologies.

Another approach has been to engineer the material compositions containing one or more active compounds in a way that the transmission system has the bulk properties to release the active compounds in a slow, predictable manner. For example, mixing one or more active compound in a diffusion-retarding matrix can moderate their release rates. For example, the volatile compound dispersed in a matrix where it has a lower rate of diffusion will release slower than the volatile compound dispersed in a matrix where it has a higher rate of diffusion. An example of one or more active compound dispersed in a diffusion retarding matrix is one or more essential oil having the active compounds mixed in carrier of a wax.

In some embodiments, the transmission system includes one or more composition, one or more carrier, and one or more release rate altering mechanism. In some embodiments, the one or more composition includes one or more active compound. In one embodiment, the one or more composition has one or more active compound and one or more non-active compound. The release rate altering mechanism may be one or more diffusion barrier, a form of the carrier, a structure of the composition, or the like. The release rate altering mechanism may affect the release rate of the one or more compound into the surrounding environment in a controlled, predictable way.

The one or more active compound of the composition may comprise, or consist of, a volatile compound, one or more plant immunostimulatory compound, one or more non-volatile compound, and one or more ethylene actor compound, or combinations thereof. The one or more volatile compound useful in the presently disclosed embodiment may include, but is not limited to, trans-2-hexenal, trans-2-octenal, trans-2-nonenal, trans-2-decenal, trans-2-dodecenal, cuminaldehyde, citronellal, thymol, perillaldehyde, carvacrol, citral, carvone, pulegone, eugenol, bornyl acetate, 1-octanol, terpinen-4-ol, linalool, trans-anethole, trans-cinnamaldehyde, ethyl octanoate, ethyl nonanoate, ethyl decanoate, methyl octanoate, methyl nonanoate, methyl decanoate, fenchol, borneol, camphor, methyl eugenol, menthol, methyl salicylate, methyl anthranilate, phenylethyl acetate, phenylacetic acid, cinnamic acetate, gamma-octalactone, gamma-decalactone, eucalyptol, geranium oil, lavender oil, thyme oil, clove oil, (−)-bornyl acetate, (−)-terpinen-4-ol, (+)-carvone, (+)-citronellal, (R)-(+)-citronellal, (S)-(−)-citronellal, (R)-(+)-pulegone, thymol, 4-isopropylbenzaldehyde (cuminaldehyde), 4-allylanisole, cis-3,7-dimethyl-2,6-octadien-1-ol, citronellol, methyl trans cinnamate, myrcene, ocimene, terpineol, 1-methyl-3-methoxy-4-isopropylbenzene, menthol, menthone, isomenthone, vanillin, geranyl formate, palmitic acid, (S)-(−)-perillaldehyde, nootkatone, hinokitiol, d-limonene, s-limonene, -cymene, nerolidol, 3-decen-2-one and other stereoisomers of these compounds, and combinations thereof. In some embodiments, the carrier material is selected from a group consisting of water, paraffin, petroleum waxes, natural waxes, beeswax, resin, synthetic polymer, biodegradable natural polymer, ceramic, modified cellulose, methyl cellulose, surfactants, mesoporous silica nanoparticles, microporous alumina, anodized aluminum, activated carbon, zeolites, metal carboxylates, inorganic compounds, and combinations thereof.

In some embodiments, the one or more compositions include one or more scent-compounds configured to offset or neutralize the scent of the one or more bioactive compounds. In some embodiments, the one or more scent-compounds is one or more furaneols (such as strawberry furanone, maple furanone, or caramel furanone), methyl cinnamate, methyl butyrate, propyl heptanoate, hexyl cinnamate, methyl anthranilate, methyl jasmonate, nonadienal, or a combination of scent-compounds.

It is understood by those of ordinary skill in the art that essential oils refer to oils distilled or extracted from plants. Essential oils are not necessarily true oils in the manner of lubricant vegetable oils but are highly fluid and exceptionally volatile. Essential oils may be complex mixtures of different organic molecules, also known as essential oil components or EOCs, monoterpenes, diterpenes, sesquiterpenes, or their oxygenated forms, terpenoids, alcohols, esters, aldehydes, ketones, phenols, thiols, isothiocyanates, and alkaloids, including but not limited to, capsaicinoids. Synthetic oils are usually made from one or more of the constituents predominant within a particular essential oil. For example, menthol often substitutes for mint and eucalyptol for eucalyptus. Further, the chemical composition of an essential oil may vary depending on time of day, the month or season the essential oil is harvested, environmental conditions leading up to and including the essential oil harvest, the means for extracting the essential oil, and for synthetic oils the chemical composition may vary from batch to batch. The environmental conditions leading up to and including the essential oil harvest include, but are not limited to, drought, excessive precipitation, and the like.

Both synthetic essential oils and naturally occurring essential oils may be used for fragrant, medicinal, antiseptic, solvents, and insecticidal purposes. For example, essential oils, such as methyl salicylate or thymol are impregnated into water insoluble resins and may be used to disseminate a fragrance or medicinal vapor into a room. Typical essential oils are obtained from thyme, lemongrass, citrus, anise, clove, aniseed, roses, lavender, citronella, eucalyptus, peppermint, camphor, sandalwood, cinnamon, cedar, almond, grapes, walnut, jojoba, olives, and the like. In some embodiments, the essential oil may also be derived from nuts or seeds. Essential oils are generally liquid at room temperature (20 C-25 C). The essential oils suitable for the present disclosure are typically commercially available and preferably refined. One or more essential oil component may be present in each essential oil.

The one or more plant immune-stimulatory compound may include, but is not limited to, pinene, camphene, terpinene, terpineol, chitosan, methyl jasmonate, and methyl salicylic acid, ethyl salicylic acid, methyl cinnamic acid, β-aminobutyric acid, fructans (inulin, levan), ethylene, harpin proteins, jasmonic acid, and the like. The one or more plant immune-stimulatory compounds refers to compounds that do not directly affect a disease-causing organism, nor alter the DNA of the treated perishable good, but instead activate a natural defense mechanism in the perishable good. It is understood to those of ordinary skill in the art that plant immune-stimulatory compound may also be known as a plant activator.

Examples of the one or more non-volatile compound may include, but are not limited to, curcumin, chitosan, phytoalexins, phytoanticipin, one or more preservative, and one or more antioxidant, including but not limited to, Vitamin E, Vitamin A, Vitamin C, beta carotene, butylated hydroxyanisole (BHA), butylated hydroxytoluene (BHT), or UV protectants such as titanium dioxide. The one or more non-volatile compounds may have a microbicidal effect, an immune stimulatory effect, and/or may prevent or slow the oxidation process in the perishable good. The microbicidal effect may reduce the infectivity of microbes, such as bacteria or fungi, which may have a spoilage effect on the perishable good. In one embodiment, the composition comprising the protective coating, one or more volatile compound, and one or more non-volatile compound may create a synergistic effect of an increased reduction in perishable good loss compared to the perishable good loss of the individual components. In another embodiment, a lower concentration of the one or more volatile compound and one or more non-volatile compound in composition with the protective coating may achieve the desired biological result faster than a higher concentration of the one or more volatile compound and one or more non-volatile compound not in composition with a protective coating. In another embodiment, the addition of the one or more antioxidant and or the one or more preservative in the transmission system may help to retain the efficacy of the bioactive formulations of the composition.

The one or more ethylene actor compound useful in the presently disclosed and claimed inventive concept may include, but are not limited to, norbornadiene, resveratrol, sodium permanganate, potassium permanganate, vanillin, activated carbon, and 1-methylcyclopropene. The one or more ethylene actor compound refers to ethylene absorbing/adsorbing or degrading compounds and compounds which remove the free ethylene from the environment, reduce its production or reduce the sensitivity to ethylene in the perishable good. An example of a volatile ethylene antagonist is 1-methylcyclopropene (1-MCP). 1-MCP binds to a plurality of ethylene receptors of the agricultural product and blocks the recognition of ethylene by the plurality of ethylene receptors. The blocking of recognition of ethylene by the plurality of ethylene receptors of the perishable good tends to reduce the effect of ethylene triggering a ripening response of the perishable good. The blocking of plurality of ethylene receptors of the perishable good also reduces an autocatalytic production of ethylene. 1-MCP may reduce the ethylene production and de-sensitize the perishable good to ethylene. Further, the ethylene actor compound may be an ethylene absorber, such as activated carbon, or an ethylene degrader, such as potassium permanganate.

In some embodiments, the one or more transmission system comprises one or more composition having one or more active compound and a carrier. The carrier may be in a solid, semi-solid, liquid, or gaseous state. The carrier may act as a medium and/or as a diffusion retardant to stabilize/hold the one or more active compound to regulate the release rate of the one or more active compound from the carrier into the environment. The carrier may be selected from a group consisting of water, paraffin, petroleum-derived wax, beeswax, plant-derived wax, resin, synthetic polymer, biodegradable natural polymer, oils and fats, ceramic compounds, one or more inorganic compound, macrocycles, such as cyclodextrins, surfactants, clays, fibers, fiber-like material, paper, and metal-organic frameworks (MOFs). Macrocycles include cyclodextrins and other similar compounds having a cage-like structure. The biodegradable natural polymer may be derived from natural plant or animal material, ceramic or inorganic compounds. In some embodiments, the carrier may be made of paraffins, wax, natural rubber, synthetic rubbers, shellac, modified celluloses, cellulose composites, semipermeable plastics, including but not limited to polyisoprene, polybutadiene, nylons (polyamides), polyurethanes, low density polyethylene (LPDE), high density polyethylene (HDPE), polyethylene terephthalate (PET), polystyrene (PS), polylactic acid (PLA), polycarbonate (PC), polypropylene (PP), polycaprolactone (PCL), polyvinyl alcohol (PVA), ethylene vinyl alcohol (EVOH), polyvinyl acetate (PVAc), polyacrylic acid (PAA), polyethylene oxide (PEO), perforated plastic films, perforated or patterned metalized plastic films, where the unmetallized parts are permeable to the active compounds, sponges, porous materials, and combinations, mixtures, blends, or composites thereof. In some embodiments, the semipermeable plastics can take any number of forms including films, granules, pellets, etc.

In some embodiments, the carrier may take any number of structures. In some embodiments, the structure may be a wax, crystalline, resin, or oleogel structure. For example, if the carrier is in a wax or oil structure, the carrier may be formed of animal waxes (natural mixtures of wax esters and sterol esters like beeswax or lanolin), plant waxes (natural mixtures of alkanes, wax esters, fatty acids, fatty alcohols, phytosterols like carnauba wax, candelilla wax, bayberry wax, soy wax), natural/vegetable oils (mixtures of natural triglycerides or processed natural triglycerides like canola oil, grapeseed oil, avocado oil, walnut oil, coconut oil, soybean oil, palm oil, hydrogenated oils), petroleum oils and waxes (mixtures of alkanes like paraffin oil, paraffin wax, microcrystalline wax), and combinations thereof. In some embodiments, when the carrier is a crystalline structure, the carrier may be comprised of fatty acids (lauric acid, palmitic acid, stearic acid, oleic acid, etc.), fatty acid salts (sodium palmitate, potassium palmitate, sodium stearate, calcium stearate, etc.), fatty alcohols (cetyl alcohol, cetearyl alcohol, etc.), and combinations thereof. In a resin structure, the carrier may be formed from natural resin or rosin, modified resins, and mixtures of resin acids like Pine resin or rosin, mastic rosin, and dammar rosin, hydrogenated pine rosin, glycerol ester of pine rosin, and mixtures thereof. In an example where the carrier is in an oleogel structure, the carrier may include combinations of waxes, and/or oils, and/or crystals, and/or resins that form a solid, gel, cream, or viscous liquid. In some embodiments, the ratios of components will adjust mechanical properties of the carrier.

In some embodiments, the carrier may have a hydrogel or gum structure, a plastic structure, or a porous solid structure. In a hydrogel or gum structure, the carrier may include collagen/gelatin, silk, gluten, zein, caseins, keratin (like wool), soy protein, pea protein, sunflower protein, polysaccharides such as cellulose, modified celluloses (such as methyl cellulose, ethyl cellulose, hydroxypropyl methyl cellulose, etc), pectin, chitosan, chitin, alginate, starch, carrageenan, agar, shellac, hyaluronic acid, gums including xanthan gum, gum Arabic, guar gum, locust bean gum, mastic, gellan gum, spruce gum, and combinations thereof. In some embodiments, the plastic structure may include natural rubber, synthetic rubbers, semipermeable plastics, including but not limited to polyisoprene, polybutadiene, nylons (polyamides), polyurethanes, low-density polyethylene (LPDE), high density polyethylene (HDPE), perforated plastic films, polyethylene terephthalate (PET), polystyrene (PS), polylactic acid (PLA), polycarbonate (PC), polypropylene (PP), polycaprolactone (PCL), polyvinyl alcohol (PVA), ethylene vinyl alcohol (EVOH), polyvinyl acetate (PVAc), polyacrylic acid (PAA), polyethylene oxide (PEO), perforated or patterned metalized plastic films, where the unmetallized parts are permeable to the active compounds, sponges, porous materials, and combinations thereof.

In porous solid structures, the carrier may include activated carbon, porous oxides (silica, alumina, titania), porous concrete mixtures, zeolites, clays, such as bentonite and montmorillonite, paper, cellulose sponge, felts, such as cellulose felt, cork, glass fiber paper, sponges such as PP sponge and PE sponge, and combinations thereof.

In some embodiments, the carrier includes a solvent or thinning agent, such as ethanol, glycerol, water, salt solution in water, such as sodium chloride, potassium chloride, calcium chloride, magnesium chloride, calcium carbonate, and mixtures thereof. In some embodiments, the carrier includes an emulsifier or a wetting agent. In some embodiments, the emulsifier or wetting agent is selected from fatty acids (lauric acid, palmitic acid, stearic acid, oleic acid, etc.), fatty acid salts (sodium palmitate, potassium palmitate, sodium stearate, calcium stearate, etc.), fatty alcohols (cetyl alcohol, cetearyl alcohol, etc.), monoglycerides (glycerol monostearate, glycerol monopalmitate, etc.), diglycerides (glycerol distearate, glycerol dipalmitate, etc.), lecithins/phospholipids (egg lecithin, soy lecithin, or sunflower lecithin), sterols (phytosterol, cholesterol, etc.), sorbitans (sorbitan laurate, sorbitan stearate, etc.), polysorbates (polyoxyethylene sorbitan laurate, polyoxyethylene sorbitan stearate, etc.), polyethylene ethers (polyethylene lauryl ether, polyethylene cetyl ether, etc.), sulfate surfactants (sodium octyl sulfate, sodium dodecyl sulfate, etc.), quaternary ammonium surfactants (cetrimonium chloride, behentrimonium chloride), and combinations thereof.

In some embodiments, the one or more active compound of the composition is released from the carrier into the environment through two mechanisms. In one mechanism, the one or more active compound may be released into the environment by way of diffusion from a carrier of the transmission system when the chemical structure of the one or more compounds which make up the carrier are modified.

Modifying the chemical structure of the one or more compounds of the carrier may include, but is not limited to, the degree of cross-linking found within the structure of the chemical structure of the one or more compounds, ratio of hydrophobic versus hydrophilic regions of the compounds which make up the carrier, manipulating degree of charge of the chemical structure of the one or more compounds, modifying the ratio of low molecular weight versus high molecular weight constituents of the one or more compounds which make up the carrier. The modifications to the chemical structure of the one or more compounds of the carrier may result in different diffusion rates of the active compounds through the carrier. The modifications to the chemical structure of the one or more compounds of the carrier may also alter the physical state of the carrier from a semi-solid state to a solid state. Generally, when the carrier is in a semi-solid state, the carrier has a lower density and a higher permeability to the active compounds. In contrast, when the carrier is in a solid state, the carrier has a higher density and a lower diffusion (also referred to as permeability or release rate).

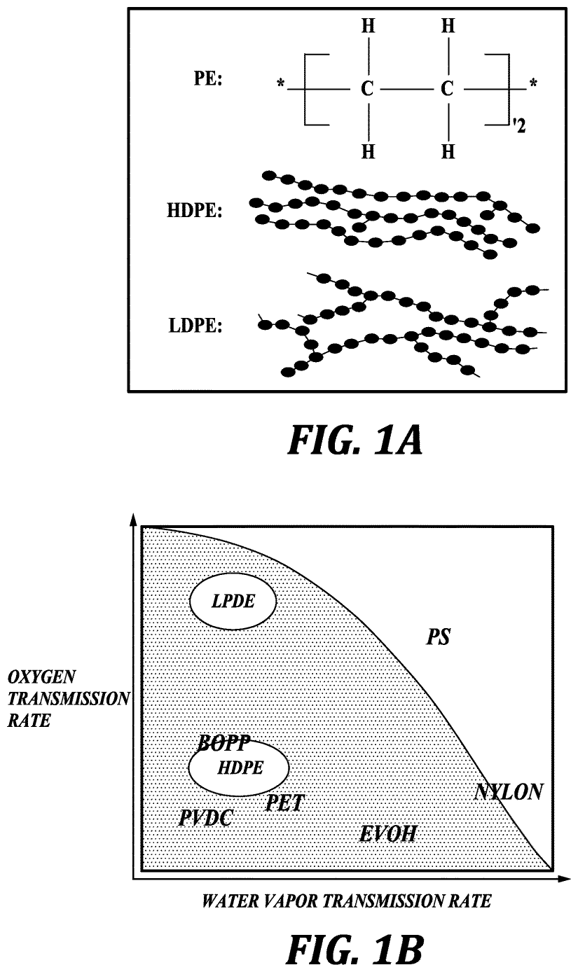

FIG. 1A shows example compounds, in accordance with the present technology. As can be seen in FIG. 1A, by way of example, when the polymer backbone branching structure of the compound of the carrier is modified, the physical properties may be dramatically affected. For example, low-density polyethylene (LDPE) versus high-density polyethylene (HDPE). The monomer building blocks are both comprised of ethylene, but the resulting LDPE and HDPE have different branching structures. HDPE is largely made of linear chains and packs tightly within the carrier. This packing of HDPE allows for the carrier to have a higher density and a higher degree of crystallinity. In contrast, LDPE has a high degree of branching, which packs less tightly in the carrier. The packing of LDPE allows the carrier to have a lower density and a lower degree of crystallinity. When the carrier is comprising HDPE and/or LDPEs, the underlying structural characteristics are responsible for the marked differences between HDPE and LDPE's mechanical and transport properties of the carrier, including the release rates of the one or more active compound from the carrier into the environment.

FIG. 1B is a graph of properties of the example compounds of FIG. 1A, in accordance with the present technology. On the horizontal axis is the water vapor transmission rate. On the vertical axis is oxygen transmission rate. The shaded portion represents optimal oxygen transmission rate. Shown on the graph are various compounds, including biaxially oriented polypropylene (BOPP), polyvinylidene chloride (PVDC), polyethylene terephthalate (PET), ethylene vinyl alcohol (EVOH), nylon, and polystyrene (PS). LDPE and HDPE as shown in FIG. 1A are also graphed and circled for emphasis.

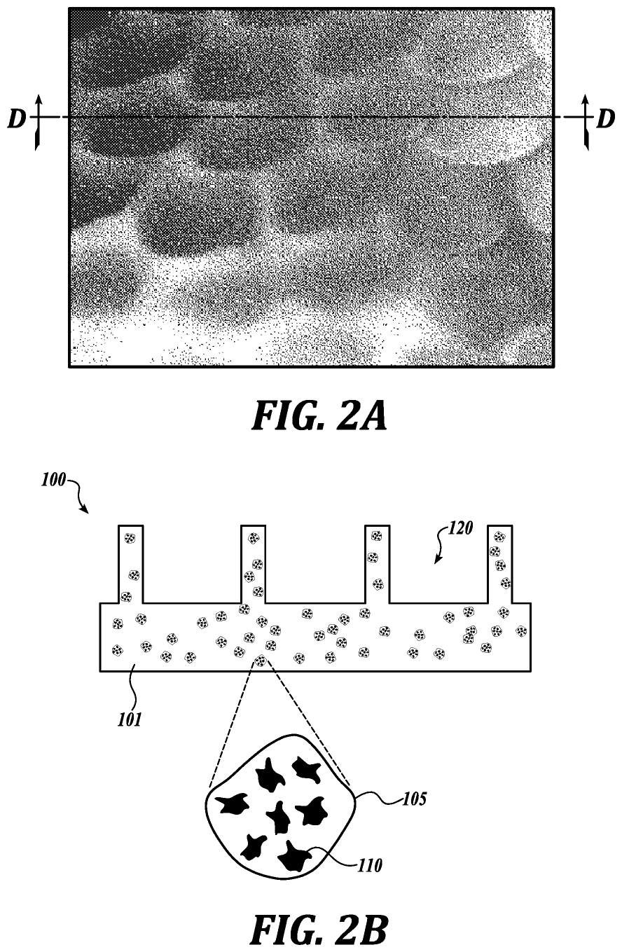

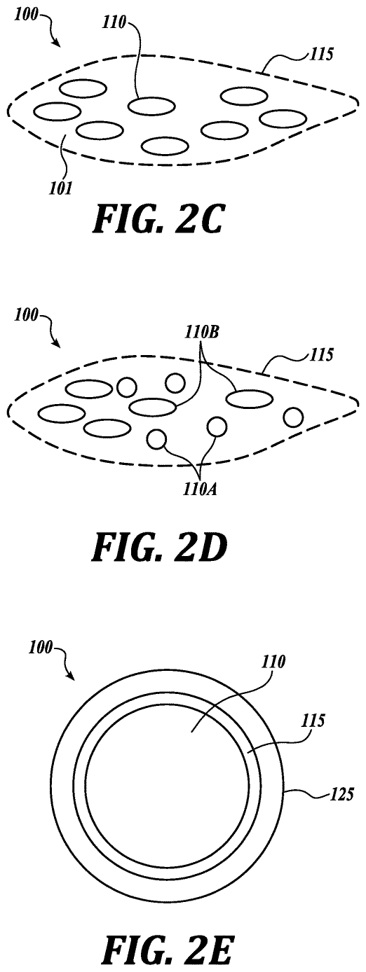

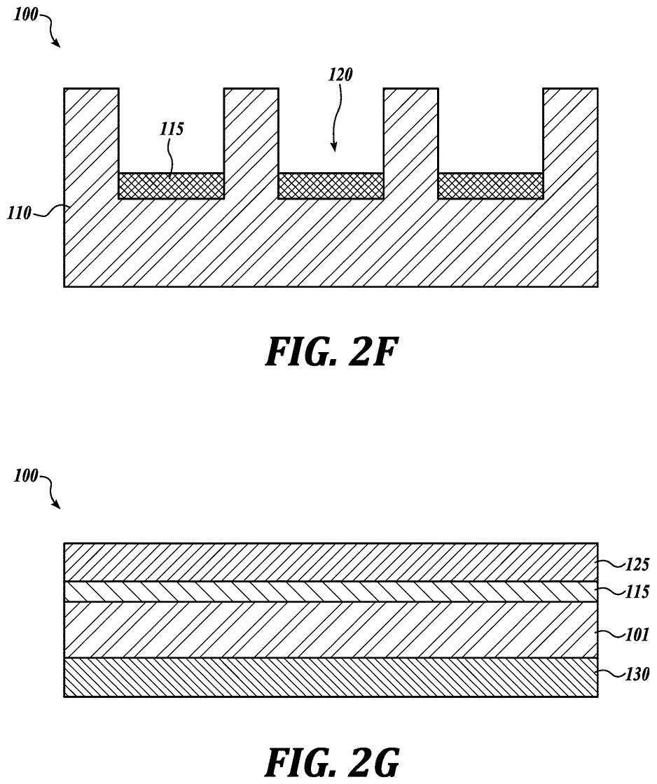

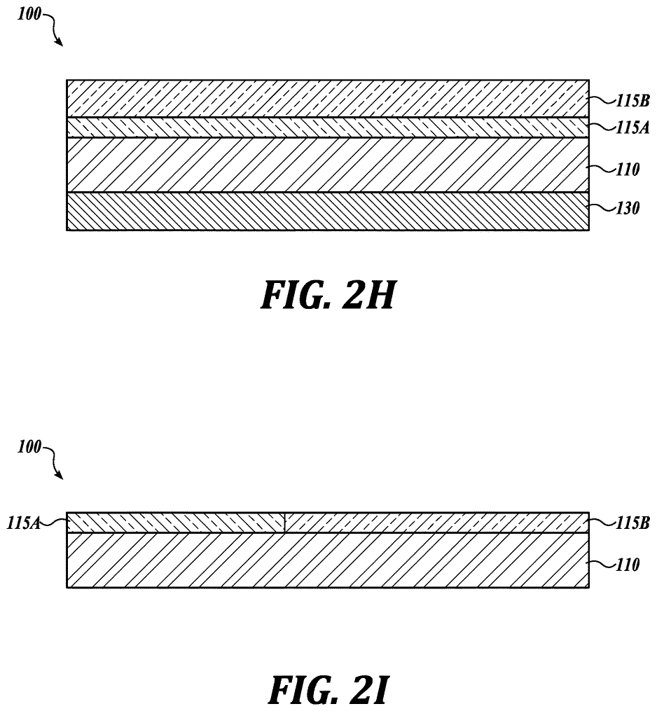

FIGS. 2A-2I are example carriers 100, in accordance with the present technology. In some embodiments, the carriers 100 can be single substances, made of blends of multiple substances, have a homogenous microstructure (such as a wax) or have a heterogenous structure, such as a porous substrate. In some embodiments, the carriers 100 may include a substance with different compounds. In some embodiments, the carrier 100 can be shaped as beads or spheres, spheroids, ovoids, dollops, small pancake like shapes, short rods/cylinder shapes, unevenly shaped granules, planar films, thick planar layers, thick layers with patterned surfaces (such as honeycomb shaped), powders dispersed in another matrix (e.g., fine powder or small granules containing active compounds mixed into a wax or paraffin as an inclusion, where the resulting wax with inclusions is shaped into a physical embodiment as described herein). In some embodiments, one or more bioactive compounds or the second granule 110B is dispersed in the carrier bulk material 101. In some embodiments, the granules 110A, 110B can be dispersed as granules 110A, 110B of purely one or more bioactive compounds, inclusions (such as inclusions 105 in FIG. 2B) containing granules 110A, 110B, or compounds uniformly mixed in with the carrier bulk material 101. In this last case, there may not be distinctively identifiable granules (e.g., drops) of compound 110 within 100, but a mixture of 101 and 110 may be inside the inclusion 105. As described herein, an inclusion 105 can be anything that is added into a carrier 100 or carrier bulk material 101. In some embodiments, inclusions 105 can be granules, of any shape or size, vesicles, beads, flakes, fibers, droplets that are solid, droplets that are gel-like, or liquid. The size scales of discrete particles, thickness of one or more layers, and the pitch and depth size scales of patterns in the case of patterned surfaces can span a range or length scales from 1 micrometer to 10 centimeters. The patterns can be largely regular, as in the case of, but not limited to a honeycomb or regular arrays of indentations, or irregular, as in the case of, but not limited to a plurality of dimples of different sizes on a surface or irregular indentations. The materials whose overall geometries and topologies described herein can have further underlying structure, as in porosity of the bulk materials. They can also have hierarchies of geometries and topologies encompassed in one another. For example, a carrier material 101, or another carrier material that is different than the bulk material that forms the carrier 100, can be made into small inclusions 105 of a certain size range (and it can be loaded with some bioactive compounds 110), as shown in FIG. 2B. These granules may be porous or non-porous. These inclusions 105 can then be dispersed into a layer of another carrier 100 that is thicker than the size scales of the inclusions 105, for example in a layer of wax which may also contain active compounds. This material made of inclusions 105 can be dispersed in a continuous homogenous or porous carrier matrix (bulk material 101) which can be shaped into a slab and its surface may be patterned to have a honeycomb structure with a certain pitch and depth, or a range of such pitch and depth values to make the carrier 100, as shown in FIG. 2A. Finally, the bioactive compounds 110 can be uniformly or non-uniformly distributed in inclusions 105, or uniformly or non-uniformly distributed in carrier material 101. In some embodiments, the bulk carrier material 101 is the main material, such as wax, porous paper etc. which a carrier is made of even if it may have additional compounds, granules or inclusions. The bulk material itself may be homogenous like a wax, or porous like paper, or it can have other microstructure within.

One or more diffusion barriers (or layers) 115 may be applied to the composition/carrier 100 to slow the overall release rate of the one or more active compound 110 into the environment adjacent to the perishable good, as shown in FIG. 2C. In some embodiments, the one or more diffusion barriers 115 are laminated diffusion barriers. In some embodiments, the one or more diffusion barriers 115 are a physically separate one or more layers, such as a film or membrane that can form a pouch or sachet, In the case of the sachet the function of the one or more diffusion barriers 115 is not necessarily a “diffusion barrier” by rather a physical enclosure that is sufficiently permeable to the active compound 110 so the loose material containing compounds 110 inside the sachet stays inside.

In some embodiments, the one or more active compound 110 is dispersed in the carrier bulk material 101. In some embodiments, the one or more active compound 110 can be dispersed as granules (as shown in FIG. 2C) of purely one or more bioactive compounds 110, inclusions in other granules (such as inclusions in inclusion 105 in FIG. 2B) containing granules of one or more active compound 110A, 110B, or one or more active compound 110 uniformly mixed in with the carrier bulk material 101. In this last case, there may not be distinctively identifiable granules (e.g., drops) of compound 110 within 100, but a mixture of bulk carrier material 101 and one or more active compound 110 may be inside the inclusion (granule) 105. The permeability of the one or more diffusion layers 115 may be affected by the material that the one or more diffusion barriers 115 comprises and/or the thickness of one or more diffusion barriers 115. In one embodiment, the permeability of the diffusion barrier 115 may be altered in response to changes in temperature and humidity. In some embodiments, any and all layers as described herein may be altered in response to triggers such as temperature and/or humidity. Similarly, oil droplets having one or more active compound 110 may be suspended in the carrier 100 that is environmentally dependent, such as a polymer matrix. For example, in another embodiment, the one or more diffusion barriers 115 may be positioned adjacent one or more carrier 100 comprising one or more composition having the active compound 110 to modify the release rate of the composition into the environment of the perishable goods. In another embodiment, the one or more diffusion barriers 115 may have a second or third composition having one or more active compound. The one or more diffusion barrier having the second or third composition having one or more active compound may slow the release rate of the one or more active compound and/or the second or third active compound into the environment adjacent the perishable goods.

In some embodiments, the carrier 100 includes a granule of a first size 110A, a granule of a second size 110B, and a diffusion barrier 115, as shown in FIG. 2D. In some embodiments, the size of each granule changes the surface to volume ratio of each type of active compound, which alters the release rate of the one or more active compound 110A, 110B. In some embodiments, the first granule 110A and the second granule 110B include the same active compound, but in other embodiments, the first granule 110A includes a first active compound and the second granule 110B includes a second active compound. All else being the same (including the one or more active compounds) inside the carrier (or sachet), the granule of the second size 110B, being smaller, will release a payload of the one or more active compounds 110B on a faster timescale, and the granule of the first size 110A, being larger will have a slower (or longer) time scale. The net effect will be a combination of both the shorter and the longer time scales.

In some embodiments, the carrier 100 includes one or more layers as shown in FIG. 2E. In some embodiments, the granule of FIG. 2E may be one of a plurality of granules embedded inside or otherwise dispersed in the carrier 100. In some embodiments, the carrier granule 100 includes one or more active compounds 110, a diffusion barrier 115, and a triggered release layer 125. In some embodiments, the diffusion barrier 115 modulates the release of the one or more active compounds 110. In some embodiments, the triggered release layer 125 triggers the release of the one or more active compounds 110 when it interacts with humidity, moisture, a specific temperature, or the like. In some embodiments, triggered release layer 125 is an impermeable barrier which triggers the release of the one or more active compounds 110 upon physical removal, such as peeling it away. In this embodiment, the impermeable triggered release layer 125 may include additional layers to help adhere it to the adjacent layers, such as a thin layer of adhesive.

In some cases, the bioactive compounds 110 to be released can form weak reversible covalent bonds with the compounds constituting the carrier bulk material 101, the compounds present in or added to the carrier bulk material 101, or some of the other compounds included in any part of the carrier 100. This includes any components or other layers that can be included in the carrier 100 shown in FIG. 2E. This way the carrier 100 can serve as a storage capacitor for the active compounds 110 where the active compounds 110 are covalently attached, rendering them less mobile and less volatile. By choosing the type of chemistry involved in attaching the bioactive 110, the reverse reaction of breaking these covalent bonds (and thereby freeing the bioactive to be released) can be fine-tuned. One example of such systems is based on a weak covalent bond found in a vast group of compounds characterized by the presence of a double bond linking carbon and nitrogen atoms, called “Schiff bases”. A Schiff base can be made by forming a bond between primary amines and aldehyde or ketone functional groups. Another example of such a system is based on a covalent bond found in a vast group of compounds characterized by the presence of a bond linking carbon and oxygen atoms, called “esters”. An ester can be made by forming a bond between an alcohol and a carboxylic acid immobilizing the volatile compound which may have either of these moieties that participated in the esterification reaction. Upon interaction with water, the ester bond can hydrolyze and release one or both of the compounds that formed the ester bonds. In some cases, the covalent bonds formed in binding the active compounds to other compounds to form Schiff bases or esters can be made responsive to various environmental stimuli. For example, the rates of breaking the covalent bonds can increase with humidity, acidity, alkalinity, temperature, or light exposure. This allows for designing “smart delivery systems” that respond to conditions in desired ways. For example, in the case of both Schiff bases and esters, the hydrolysis rate that breaks these covalent bonds thereby frees the active compounds to become more mobile and volatile increase with the action of an “activator”. The activator can include humidity, acids, alkalines, or some combinations of these. The acid activator compound can be acetic acid, citric acid, ascorbic acid or any other acid or their combinations. The alkaline activator compound can be sodium carbonate, sodium bicarbonate or any other alkaline or their combinations. In some embodiments, such covalently bound active compounds can be placed in close vicinity of an acid activator or alkaline activator in a way they are not initially able to react with one another. For example, they may be placed in different compartments physically separated from one another as in multicompartment blister packs or glow sticks. The separator can be mechanically broken to allow mixing of the compounds and hydrolysis of the covalent bonds. This action can be used to activate the system and commence the release of active compounds on demand by a user, or during manufacturing. In another embodiment, the active compounds and the activators can be dispersed in a continuous matrix (bulk material 101) as discrete solid granules or liquid or gel droplets which remain physically out of contact with one another. In some embodiments, the activator granules dispersed in the bulk material 101 may be solid granules of citric acid or any other acid. In some embodiments, these solid granules are crystals. Upon ingress of humidity in the use environment, the activators can start dissolving in the matrix and diffuse through it to reach the covalent bonds and hydrolyze them releasing the bioactive compounds. The humidity needed for activation can passively come from the use environment, in the presence of fresh produce, or be performed on demand, for example by misting or spraying water on the embodiment to activate it. This can be done by a user, or during manufacturing in the packaging step. In another embodiment the active compounds covalently bound to another compound to form esters or Schiff bases is included without the activator in its close vicinity. The activator, such as a citric acid solution, is misted or sprayed onto the embodiment by the user or during manufacturing to activate it and commence the release of bioactive compounds.

In another embodiment, the release rate altering mechanisms may be based upon the structure of the composition and the form of the carrier 100. The structure of the composition may include macroscopic, mesoscopic, and microscopic geometries, such as beads or inclusions 105 of various sizes; small pellets with specified sizes and aspect ratios; honeycomb structures (as shown in FIG. 2A), and other multilayer constructions of the composition. The form of the carrier 100 and any one of its components, for example, may also include various amounts of porosities. The macroscopic, mesoscopic, and microscopic geometries of the structure of the composition and the form of the carrier 100 may affect the transfer and release rate of the composition into the environment of the perishable good. In one embodiment, the quantity of the one or more active compound 110 within the composition and the structure of the composition affects the release rate of the composition into the environment of the one or more perishable good. In another embodiment, the release rate of the one or more active compound 110 may be affected by proportion of the amount of the active compound 110 within the composition versus the volume of the composition based on the structure of the composition and the form of the carrier 100. For example, the porosity of the carrier 100 may affect the transport of the composition within the transport system. In another embodiment, the structure of the composition and/or the form of the carrier 100 may be combined in one transmission system to achieve highly complex release profiles. For example, a transmission system comprising one or more composition comprising one or more active ingredient 110 and one or more carrier 100 formed into one or more shape suitable for releasing the composition into the environment of the perishable goods at a rapid release rate, whereas, a transmission system comprising one or more composition having one or more carrier 100 formed into one or more shape may release the composition 110 into the environment of the perishable goods at a slower release rate.

In one embodiment, the form of the carrier 100 may be porous. Examples of carriers being porous include, but are not limited to mesoporous Silica, anodized Aluminum, sponges, foams, cellulose matrices such as papers or cardboard, and various polymers, etc. The porous carriers 100 may vary in its porosity, pore size distribution, tortuosity, and transport properties of the one or more composition of the transmission system. In one embodiment, the one or more composition 110 may be positioned within one or more pore of the porous structure. These pores may be microscopic and may be present throughout the components of the carrier 100, and therefore not illustrated for simplicity. In particular, the one or more pores may be located in the carrier bulk material 101 as opposed to only being a surface pattern. One skilled in the art should understand that in some embodiments, the one or more pores are like those in a sponge, or similar to the pores (microscopic physical gaps) within a compacted cellulose (paper-like) piece. In some embodiments, the porous material (i.e., the bulk carrier material 101) could be further patterned to make surface topology 120 in FIG. 2B. By way of example, but in no way limiting, one or more compositions 110 in combination with a carrier 100 comprising beeswax may be positioned within the one or more pore in the carrier 100 comprising a mesoporous material, or within the cavities of the surface patterns 120. In some embodiments, the one or more composition filling the pores in 100, or patterns 120 may be selected from one or more essential oils or blends of essential oils, one or more liquid compositions comprising active compounds and a liquid solvent, such as oil in a liquid carrier, or liquid emulsions of vesicles as described herein, gel or other wax compositions comprising active compounds and other carriers, or other solid compositions with active compounds, which may be impregnated into the pores while in a liquid state. In some embodiments, the solid composition is a liquid at an elevated temperature or is a liquid in a solution made by a highly volatile solvent, such as ethanol, where, after filling the pores, the solvent evaporates leaving the dry composition in the pores in the carrier 100, or in the surface patterns 120.

In another embodiment, microscopic morphology of the carrier material 101, or any part of the carrier 100 may be microporous. The one or more active compounds are released into the environment via the microporous structure (“pores”) of the carrier, or through the cavities defined by the surface patterns 120. The pores or cavities have a space devoid of any material, or may contain one or more other materials, including one or more active compound in any physical state. In one embodiment, the pores, or cavities 120 may be singular; i.e., one pore surrounded by the carrier 100 from all sides. In another embodiment, the pores or cavities 120 may be two or more; i.e., two or more pores may be surrounded by the carrier 100. In another embodiment, the network of pores may be physically connected providing one or more pore pathway positioned within the carrier 100. In one embodiment, the one or more pore pathway may be positioned adjacent to the environment surrounding the perishable good. Examples of the carrier 100 having a microporous structure include but are not limited to mesoporous silica nanoparticles, microporous alumina, and anodized aluminum having an anodization layer. Mesoporous silica nanoparticles have unique characteristics such as an orderly arrangement of pores, biocompatibility, and may be used as a control release mechanism. The mesoporous silica nanoparticles may be incorporated into other matrices such as packaging and wax to further influence control release characteristics. Characteristics of pores or surface cavities 120 in these materials may be controlled so as to yield the desired controlled release characteristics. One or more surface of the mesoporous silica particle carrier and the microporous alumina carrier may also be chemically modified to change the hydrophilicity, the hydrophobicity, or directly hold the compound by chemically attaching cyclodextrins to the compound. In one embodiment, the carrier may be modified by a molecular nanoimprinting process. The molecular nanoimprinting process imprints a resin with a molecule while the compound sets to make the surface cavities defined by the patterns 120 of the carrier 100 molecule-specific.

In another embodiment, the structure of the composition may have a particle configuration (such as inclusion 105) of a powder, granule, or the like, as shown in FIG. 2B. A plurality of particle configurations may be altered into a desired macroscopic shape such as a tablet, ball, disc, or the like. In one embodiment, the microstructure of the macroscopic shape may be optimized to achieve a certain level of porosity between the powder/granules. The macroscopic shape can be further optimized to achieve different surface to volume ratios. The process of forming the macroscopic shape determines the surface to volume ratio of an individual particle configuration as well as macroscopic shape of the plurality of particle configurations. In another embodiment, the plurality of particle configurations may also be formed into a macroscopic shape having one or more pore, or various surface patterns 120.

In some embodiments, such as shown in FIG. 2F, one or more pore or the surface cavity 120 of the macroscopic shaped carrier 100 may be impregnated or backfilled with a substance 115 such as a resin, hydrogel, viscous liquid, or the like. The substance 115 may serve as a barrier (such as a diffusion barrier as described herein) affecting the release rate of the one or more active compound 110 from the one or more patterned cavity 120 of the macroscopic shaped carrier 100. In another embodiment, the one or more patterns 120 may be inert and serve as a scaffold, as shown in FIG. 2B. The one or more pattern serving as a scaffold may have a diffusion retarding matrix positioned within the one or more pattern. In one embodiment, one or more composition may be a plurality of bead particle configurations varying in size. The plurality of bead particle configurations having a smaller size have a higher surface-to-volume ratio. The plurality of bead particle configurations having a smaller size will have a faster release rate for releasing the one or more active compound to reach a target gas concentration. The plurality of bead particle configurations having a smaller size will dispense of the one or more composition at a faster rate. The plurality of bead particle configurations having a larger size, as such having a smaller surface-to-volume ratio, may maintain a target concentration over a longer period of time. In another embodiment, the plurality of bead particle configurations may be coated with the one or more diffusion barrier. The one or more diffusion barrier may slow down the release rate. In some embodiments, the plurality of beads can range in size from 1 micron to 1 centimeter in diameter. It should be understood that this diameter is the diameter of a similarly sized sphere when the carrier is an irregularly shaped granule. In some embodiments, the thickness of the carrier may range from 1 micron to 1 centimeter.

In another embodiment, the one or more active compound may be infused into packaging materials such as plastics, trays, bags, or the like. The one or more composition may be coated onto a surface of an object that is positioned adjacent to the perishable goods. An example of an object would be a tray, carton, or the like.

In another embodiment, one or more composition having one or more active compound may be positioned within the carrier comprising a material capable of being molded. The carrier may be a wax, a paste-like material, a porous structure, or a microemulsion dispersed within a gel-like substance, or the like. The carrier may be formed into various shapes defining a range of surface-to-volume (S/V) ratios. The surface to volume ratio of the form of the carrier may also affect the rate of release of the one or more active compound. The distance (d) the one or more active compound must advance from a first position within the carrier to the surface of the carrier may also affect the release rate of the one or more composition. For example, but in no way limiting, a spherical particle configuration would have a radius d. As a general rule, the total surface area of a particle configuration goes as ~d² whereas the volume of the particle configuration goes as ~d³. Even if the basic shape is the same (e.g., beads, spheroids etc.), the smaller the size of the radius, the higher the surface to volume ratio of the particle configuration. Therefore, the release rate of one or more active compounds from a smaller particle configuration will be faster than that in a larger particle configuration. Therefore, when the one or more active compound needs to be released to the environment adjacent the perishable good faster, the physical embodiments having high S/V ratio would be favored. Conversely, when the one or more active compound needs to be released to the environment adjacent the perishable good slower, the physical embodiments having small S/V ratio would be favored. For example, the transmission system having a carrier comprising wax having a thin, sheet form will have a faster release rate of the one or more active compound than the transmission system having a carrier comprising wax having a thicker, disc shaped form. An increased surface to volume ratio may have the form of the carrier as a honeycomb, dimpled carrier, ribbed carrier, finned carrier or a similar three-dimensional carrier in order to obtain even more surface area to volume ratio. In contrast, when a slower release rate is desired, the same amount of one or more active compound may have a carrier formed into shapes with smaller surface to volume ratios, such as large spheres, cylinders, or the like. In some embodiments, when the carrier has a diameter ranging from 1 micron to 1 centimeter, the S/V ratio range is 6000 to 0.6 1/mm.

In another embodiment, the surface to volume ratio may be determined by varying the size of the particle configuration. For example, a sphere having one particle having a diameter of 1 centimeter would have a total volume of approximately 0.5 milliliters. If the size of the spherical particle configuration had a 1-millimeter diameter, the 1-centimeter sphere comprising same total amount of material as one-thousand of the 1-millimeter in diameter beads, increasing the total surface area ten (10) times that of the 1-centimeter spherical particle configuration. Merely changing the size of particles changes the relative surface area by the same ratio for a given total amount of material. Therefore, the same quantity of composition divided into a plurality of particle configurations release the active compounds faster than a single particle configuration of the same quantity. In another example, 1 gram (g) of the composition having 0.1 grams of one or more active compound dispersed in 0.9 grams of a carrier such as a diffusion retarding matrix like a wax is disclosed. If the transmission system was formed into a single spherical particle configuration, the particle configuration will have a slower release rate than if the transmission system was formed into a plurality of smaller spherical particle configurations.

In another embodiment, the amount of the one or more active compounds released into the environment adjacent to the perishable good may be modified by varying the quantity of the one or more composition in varying structure of the composition and/or the form of the carrier. In one example, in an environment having a “large head space volume” adjacent to the perishable good that requires a higher release rate of the one or more active compound would use transmission system having a surface to volume ratio of 6000 to 0.6 1/mm. An example would be the plurality of spherical particle configurations having a diameter of 1 millimeter and a surface to volume ration of 6 1/mm. In another embodiment, if the environment adjacent the perishable good has a “smaller head space volume” requiring a lower release rate the plurality of larger spherical particle configurations may be positioned within the environment adjacent the perishable goods.

In another embodiment, the carrier may have a form of one or more layer having one or more composition. The carrier 100 may be a plurality of layers, as shown in FIGS. 2G-2I. In one embodiment, the plurality of layers may be positioned between one or more diffusion barrier 115, thereby slowing the release rate of the one or more active compound 110. In some embodiments, the carrier 100 may include a substrate 130, a bulk carrier material 101, a diffusion barrier 115, and a triggered release layer 125. In some embodiments, the one or more active compounds can be present in any of the layers shown or described herein. In some embodiments, the triggered release layer 125 is triggered in response to humidity, temperature, or the like. In another embodiment, a carrier 100 having a plurality of layers (as shown in FIGS. 2G-2I) may also have a pulsed release rate. By positioning the bioactive compounds 110 adjacent to one or more diffusion barrier 115A, 115B, a high concentration of one or more active compound may be released over a shorter period of time. In some embodiments, by alternating diffusion barriers 115A, 115B and/or bioactive compounds 110 layers, this time period may release high concentrations of the one or more active compound 110 into the environment adjacent the perishable goods over a predetermined time interval. In some embodiments, this is accomplished by including plurality of S/V ratios made of the same components, using different components for 100 for different compounds 110 and then using the plurality of these different versions of carriers 100, or a combination thereof. In one embodiment, the transmission system (or carrier) 100 having multiple layers may release pulses of high concentration of one or more active compound followed by long periods of time of no or very little release of high concentration of one or more active compound.

In some embodiments, porous paths may be included throughout the carrier 100. For example, in some embodiments, the entire carrier 100 may be porous to various degrees. This orientation effectively provides a continuous path from the inside of the bulk material to the exterior in an open pore structure. The open pore structure furnishes a medium with different transport/permeability characteristics than a singular transmission system comprising one or more active compound and the carrier. For example, in the case where pores of the open pore structure are left “empty” and simply allowed to fill with a gas (e.g. ambient gas and/or gas emitted from the continuous phase), the pores may provide a fast diffusion path thereby increasing the apparent bulk diffusivity.

In another embodiment, the carrier of the one or more transmission system further comprises one or more additive compound. The one or more additive compound acts to modulate the release rate of the one or more active compounds into the environment by changing the physico-chemical behavior of the one or more active compound. The one or more additive compound may be selected from a group consisting of, but not limited to, macrocycles, such as cyclodextrin, urea, surfactants, such as, antioxidants, Vitamin A, Vitamin C, Vitamin E, beta-carotene, polymers such as poly(N-isopropylacrylamide) and the like, and ionic elements or compounds, such as, sodium chloride, calcium chloride, calcium carbonate, and ammonium carbonate. For example, the macrocycles may be combined with the carrier. Macrocycles include a family of compounds having cage-like molecular structures, including cyclodextrin. This combination will form inclusion complexes with the one or more active compound, slowing the release rate of the one or more active compound from the carrier into the environment. Natural antioxidants, such as Vitamin A, Vitamin C, Vitamin E, beta-carotene, and the like, would also have an active control over the release of a composition, typically by reducing the vapor pressure of the one or more active compounds. Natural ionic compounds, such as sodium chloride, calcium chloride, and the like, would also have an active control over the release of a composition. Combinations of ionic compounds and volatile compounds can either increase or reduce the vapor pressure of the volatile compounds, depending on complex interactions between the molecules and their relative amounts in the carrier.

In other embodiments, the release rate of the one or more active compounds from the carrier into the environment may be affected by the presence of stimuli. For example, the stimuli may be an additional compound creating a competitive replacement system. In use, the competitive replacement system includes the addition of an additional compound to the transmission system. The carrier of the transmission system may have a greater affinity for the additional compound versus the compound already in combination within the composition of the transmission system. The competitive replacement system will replace the compound already in combination within the composition with the additional compound. By way of example, but in no way limiting, in some embodiments the addition of ethylene to the transmission system may replace the compound present in composition. Thus, the competitive release system responds to an increase in ethylene produced by the post-harvest ripening of fruits or vegetables by replacing, and therefore releasing, the compound in composition of the transmission system that has antifungal properties. In one embodiment, the presence of moisture to the transmission system may cause the compound in composition to be released into the environment near the perishable good at an increased rate. In another embodiment, the transmission system may have a barrier layer in combination with one or more active compounds. The barrier layer of the transmission system may be sensitive to temperature and/or humidity. For example, a modified cellulose, like methyl cellulose, has a lower critical solution temperature (LCST) that may be designed to be present in a specific temperature range. Methyl cellulose has an LCST at ~45 C. Below 45 C methyl cellulose is water soluble and will soak up water and transition to a gel-like physical state. Above 45 C methyl cellulose will expel water and will transition to a solid-like state. The diffusion barrier may have altered permeability in response to fluctuations in temperature and humidity and therefore modulate the transmission system's release rate based on the environment.

In another embodiment, the composition of the transmission may be responsive to the presence of one or more environmental conditions by causing the transmission system to expand in size or reduce in size. Compounds may be cross-linked to allow the transmission system to hydrolyze or oxidize in response to the one or more environmental condition. Examples of the environmental condition include but are not limited to increased water in the atmosphere surrounding the perishable goods, an increased presence of oxygen in the atmosphere surrounding the perishable goods, or the like. For example, polymer carriers that are cross-linked by ester bonds are unstable and hydrolyze in high humidity. Such a carrier's structure, including its permeability and porosity, would change upon exposure to high humidity, modulating the release rate of the transmission system.

In another embodiment, the one or more transmission system comprises one or more active compound and a plurality of vesicles. The one or more active compound is positioned within the plurality of vesicles forming nano-emulsions or micro-emulsions. The plurality of vesicles may range in size from approximately ten nanometers to approximately one micrometer. The transmission system may be formed as thermodynamically stable or metastable by the addition of, but not limited to, one or more surfactant and using the appropriate processing methods.

A microemulsion may be very complex and may contain many compounds, as a conceptual model it has at least three distinct components: For example, an oil in water (O/W) emulsion will have a surfactant, a continuous phase (such as water), and a discontinuous dispersed phase (such as oil) that gets trapped inside the vesicles. Depending on the relative proportions of these components, various microstructures may be formed.

In one embodiment, the one or more transmission system comprising a plurality of vesicles and one or more active compound, specifically one or more essential oil, or one or more essential oil component, and the dispersion of the transmission system in a continuous phase such as water, may affect the overall release of the one or more active compounds into the environment. It is understood to those of ordinary skill in the art that the transmission system may be altered modifying relative ratios of the one or more active compounds. It is also understood to those of ordinary skill in the art that the use of various surfactants, emulsifiers, and size of the plurality of vesicles may form various permeabilities for the one or more active compound positioned within the plurality of vesicle (or from the vesicle surface/skin into the continuous phase). Further, the modification of the one or more active compound and the properties of the continuous phase may moderate the release rate. In another embodiment, the modification of the ratio of the one or more active compound in the emulsion may moderate the release rate of the one or more active compound from the vesicle into the environment. In other embodiments, transmission systems having vesicles and/or microemulsions having one or more active compound may be suspended in a polymer matrix having a permeability that is dependent on the temperature and humidity of the environment surrounding the transmission system.

In another embodiment, the one or more transmission system may be the emulsion of the one or more active compound having oil-like properties, prepared in an aqueous continuous phase having one or more gelling agents. After the formation of the emulsion, a portion of water in the aqueous continuous phase may be evaporated leading to the formation of the transmission system being in a gel-like state with the one or more active compound having oil-like properties dispersed throughout in the form of microemulsions.

In another embodiment, the one or more transmission system comprises one or more active compound positioned within one or more capsules. In one embodiment, the one or more active compound may be in combination with a gel-like material. The one or more capsule may range in size from about 0.05 centimeter to about 3.0 centimeters. The one or more capsules may have an outer shell. The outer shell of the one or more capsule may be comprised of a material permeable to the one or more active compound. For example, the material may comprise, but is not limited to, cellulose, polymers, natural sugar polymers, such as alginate, carrageenan, chitosan, synthetic polymers, such as, polyethylene glycol, or the like. The overall release rate of the one or more active compound may be controlled through the selection of the material for the one or more capsule and the thickness of the material chosen for the one or more capsule.

In another embodiment, the transmission system having the one or more composition having one or more active compound and the carrier may be positioned within the one or more capsule macroscopic in size. A macroscopic size capsule has a diameter of about 0.2 centimeters or larger. One example would be a transmission system having the composition having the physical embodiment of a powder or granule in combination with a wax or gel carrier placed within a capsule having a diameter of 0.5 centimeters. The one or more capsule may comprise a material which is permeable to one or more active compound. The release rate of the one or more active compound may be affected by the material and/or the thickness of the outer shell of the capsule. In another embodiment, the release rate may be affected by distributing an equal amount of the composition within a smaller in size but higher in number of one or more capsules which results in a higher surface-to-volume ratio. In general, this will make an embodiment that utilizes one or more capsules have a faster release rate of the one or more active compound.

In one embodiment, the transportation system may have two or more compositions having distinct release requirements. For example, the transmission system may have composition 1 (C1) having a faster release rate that causes C1 to be released into the environment adjacent the perishable goods first and composition 2 (C2) having a slower release rate that causes C2 to be released into the environment adjacent the perishable goods second. These releases may be sequential, but they also may occur simultaneously, proceeding at different rates.

Any suitable format of the one or more transmission system described above (carrier, vesicle, microemulsion, capsules, etc.) may be arranged in various macroscopic configurations resulting in different surface to volume ratios. Generally, when the one or more active compound is required to be released into the environment at a more rapid release rate, the transmission system which has a high surface to volume ratio would be favored. For example, the carrier comprising wax having one or more active compound pressed into thin flat sheets. Alternatively, the transmission system may be formed into a honeycomb or similar pattern in order to obtain even more surface area with the same footprint. In some embodiments, the composition may be formed into a flat or patterned sheet, including with a honeycomb structure, that conforms with the inside of a container, package, box, or any suitable surfaces in an environment. In some embodiments, the compositions configured to conform can be attached, coated, laminated, or otherwise secured on the surface, container, box, or package. In contrast, when a slower release rate over more extended periods of times is desired, the transmission system may be formed into shapes with smaller surface to volume ratios, such as large spheres or cylinders. Another way of manipulating surface to volume ratio would be to form the transmission system by using different particle sizes of the same basic shapes. Merely changing the size of particles changes the relative surface area by the same ratio for a given total amount of material. All else being equal, the same quantity of the one or more active compound made into smaller particle sizes would release the one or more active compound at a more rapid release rate than if the one or more active compound was ground up into a coarser size. In summary, the overall release rate may be controlled through any one or any combination of these macroscopic geometry choices of the transmission system.

In some embodiments, one or more diffusion layer 115A, 115B may be separately applied to surface of the composition comprising one or more active compound 110 in order to slow the overall release rate of the one or more active compound, as shown in FIG. 2H. In one embodiment, the one or more diffusion layer 115A, 115B may or may not have an active compound present. In another embodiment, one or more diffusion layer may be constructed as one diffusion layer 115A adjacent to one or more diffusion layer 115B as shown in FIG. 2I. In this embodiment, each diffusion layer of the one or more diffusion layer may have the same active compound, different active compounds, or no active compounds present in the diffusion layer. An example of the diffusion layer being constructed as one diffusion layer adjacent to one or more diffusion layer is a plurality of diffusion layers being wrapped around a perishable good (plastic wrap), droplets of beeswax being dispersed in a matrix of a wax having a different composition. The one or more diffusion layer may be selected from a group comprising natural polymers, synthetic polymers, paraffins, natural waxes, paper, clays, ceramics, or the like. The permeability of the one or more diffusion layer may be determined by the thickness of the one or more natural polymers, synthetic polymers, paraffins, waxes, paper, clays, ceramics, or the like. Further, the permeability through these diffusion barriers may be determined or manipulated by the properties of the material, the thickness of the diffusion barrier, the micro-patterning or patterning of the diffusion barrier, and any physical perforations in the diffusion layers. When higher permeability is desired, the relative proportions of the microperforations or the hole sizes of the micro perforations across the surface of the diffusion barrier are increased.

The transmission system made up of all the varying embodiments (including differences in chemistry, shape, physical construction, etc.), can be combined in “packages” or products where a plurality of transmission systems acts independently within close proximity of one another. The plurality of transmission systems creates an overall release or one or more active compound, which may be difficult to achieve with a singular transmission system design. Specifically, the net release behavior of the plurality of the transmission systems observed will be a superposition of the responses of all of these delivery systems collectively. For example, a fast-releasing component, such as small spherical beads, and a slow-releasing component having different chemistry and/or larger particles, such as sachets, may work together to reach targeted concentrations to achieve a biological result.

It is understood by those of ordinary skill in the art that the present disclosure may also be applicable to various items including but not limited to food, fibers, implements, household cleaning products, healthcare environments, and construction surfaces to preserve their integrity and prevent the presence of various fungi, molds, and other microorganisms. Such compositions can also be applied to building structures, plant parts, and even clothing items or shoes for their preservation or to reduce off-odors.

The ideas presented here can also be broadened to many other application areas beyond preservation of perishable goods. For example, other food products such as aged cheese, cured meats, etc., which may be susceptible to spoilage, can be protected with these technologies. Furthermore, as the volatile antimicrobial active compounds often have genus-, species- or strain-level specificity of action spectrum, the volatile antimicrobial active compounds can be chosen among those that do not have a suppressing effect on the growth of desirable organisms (e.g., in moldy cheeses, such as Roquefort or Camembert cheeses) while suppressing the spoilage-causing organisms.

Other applications may include (1) environmental sanitation; for example but in no way limited to, household cleaning solutions that are safe, natural, and not require spatial precision; (2) healthcare applications, for example but in no way limiting, forming a biofilm on medical devices that come into direct contact with people, such as by forming a biofilm inhibition solution that can function at a distance; (3) other industries that have recurring issues with fungal or bacterial growth such as leather production; for example, veterinary services.

### EXAMPLES

In the following examples, the equilibrium vapor pressures are measured by allowing samples to release the volatiles in a closed container and measuring the concentration (Vapor pressure) as it levels out under given conditions. Concentrations in the gas phases (Vapor pressures are measured by handheld photo ionization detectors or gas chromatographs).

In some embodiments, as described herein, a Schiff base is utilized. Schiff bases contain weak covalent bonds characterized by the presence of a double bond linking carbon and nitrogen atoms. A Schiff base can be made by forming a bond between primary amines and aldehyde or ketone functional groups.

As an example, chitosan has primary amine side chains. It will form reversible bonds along the polymer chain with aldehyde or ketone functional groups under mild conditions (50° C. in dilute acetic acid solution). The resulting chitosan-aldehyde Schiff base itself is not volatile, as chitosan is a large, non-volatile molecule. A volatile aldehyde can be reversibly attached to chitosan in this manner. Under dry conditions the Schiff Base is highly stable, and the aldehyde remains attached. Under high humidity conditions the Schiff Base is unstable, and converts back to chitosan and aldehyde, which is then free to release.

In the following example, the aldehyde used was trans-2-hexenal. This is an example of a “smart” delivery system developed that responds to relative humidity (RH) and releases its trans-2-hexanal payload more under higher relative humidity conditions. Here RT VP is the equilibrium vapor pressure (VP) measured in a jar containing the sample at room temperature (RT) expressed in the units of PPM as typically measured by a handheld photoionization detector. As can be seen in Table 1, the pure aldehyde has very high volatility (VP of 6000 PPM). When it is made into a Schiff base, because the covalent bonds bound and retard the release of the aldehyde, the VP is dramatically reduced. Moreover, due to the sensitivity of the covalent bonds in Schiff base to the humidity, the equilibrium VP is changed with changing humidity.

TABLE 1
equilibrium vapor pressure at room temperature from compositions
coated onto equally sized paper test coupons.

| Sample | RT VP (PPM) |
|---|---|
| Pure chitosan, RH 40% | 0 |
| Pure trans-2-hexenal, RH 40% | 6000 |
| Schiff basc, RH 10% | 0.7 |
| Schiff base, RH 40% | 5 |
| Schiff base, RH 80% | 11 |

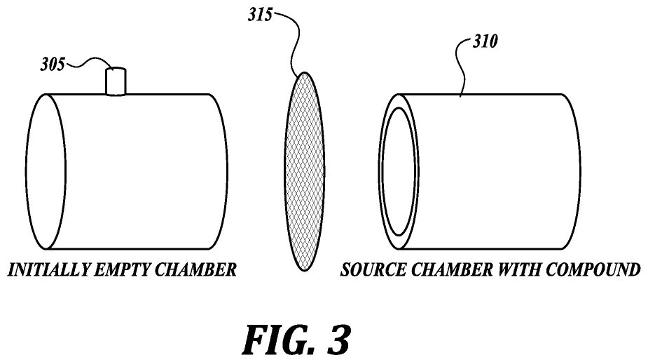

FIG. 3 is an example diffusion cell, in accordance with the present technology. The permeability of thin membranes, films, or slabs of materials to specific volatile compounds can be measured with a diffusion cell. The materials may be single materials, heterogenous blends, or composites made up of multiple layers or otherwise defined architecture. A diffusion cell has two compartments separated by the material to be tested, which is formed into a flat sheet or film. The volatile compound whose diffusivity through the test material is to be studied is placed in one of the compartments at time zero. The other compartment is empty at time zero. The concentration of that compound in the gas phase in the compartment that is initially empty is measured as a function of time. In the figures below, vapor pressure (VP) is one measure of concentration. This is shown schematically in FIG. 3.

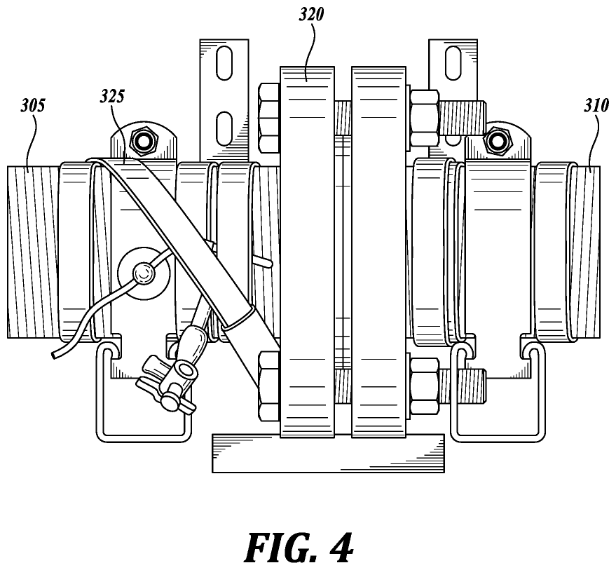

FIG. 4 is a test fixture, in accordance with the present technology. The test fixture includes two compartments formed with stainless steel pipes. The flange in between them is used to secure the test material between the compartments and form an airtight seal. The entire assembly is wrapped in heat tape for cases when the test needs to be conducted at elevated temperatures.

In some embodiments, a thin film, membrane, or slab has a thickness of about 0.15 mm. In some embodiments, the diameter of the membrane is 3 inches (or about 7.6 cm). A high concentration of volatile compound is trapped in a known volume on one side of a membrane with a known exposed area. The volatile is allowed to diffuse through the membrane and its concentration is measured on the other side as it passes through. The membrane's thickness and exposed area and the volatile's flux through the membrane can be used to calculate the membrane's permeability to the volatile and the volatile's diffusivity in the membrane material.

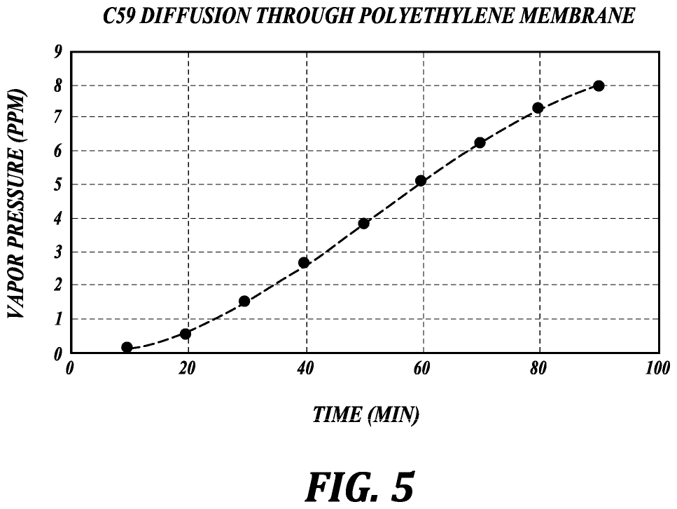

FIG. 5 is a graph showing diffusion through an example membrane, in accordance with the present technology. On the horizontal axis is the time in minutes. On the vertical axis is the vapor pressure in parts per million (PPM). Plotted is the C59 (a volatile compound of interest) diffusion through a polyethylene membrane.

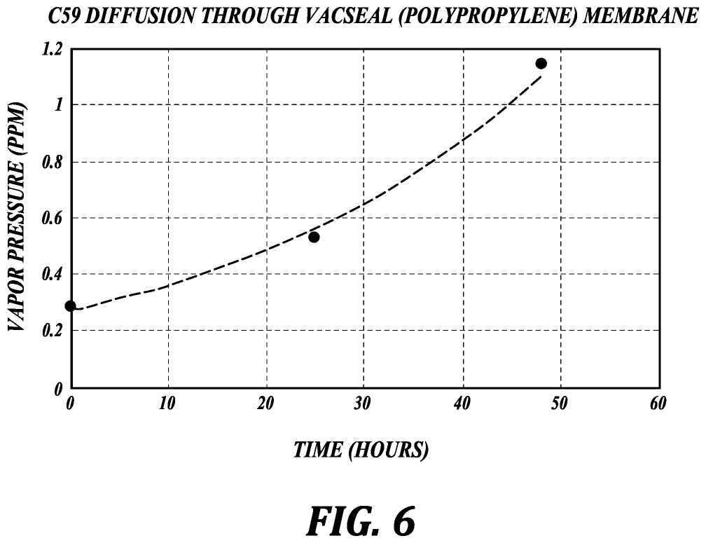

FIG. 6 is a graph showing diffusion through another example membrane, in accordance with the present technology. On the horizontal axis is the time in hours. On the vertical axis is the vapor pressure in parts per million (PPM). Plotted is the C59 diffusion through a polypropylene membrane.

FIGS. 5-6 show the differences in permeability of two different materials of the same thickness to the same compound, denoted C59. The polyethylene membrane has lower permeability to the compound than the polypropylene membrane evidenced by the slower rise in the concentration (Vapor pressure) of the compound in the chamber that was initially empty. Thus, in some physical embodiments, layers or structures made from one or more materials can be used to adjust the overall release rate.

PTFE, FEP and PET membranes were also studied, but diffusion through these membranes were too slow to measure the permeability and diffusion coefficients reliably with the current test device setup. Thus, PTFE, FEP, and PET samples tested are far less permeable to C59 than the PP and PE samples tested.

Applying a wax diffusion barrier layer outside of carriers containing active compound(s) can modulate compound vapor pressure and release rate. Volatile essential oil compounds (EOC) were loaded into a fiber-based matrix as either pure liquid or encapsulated in a carrier (natural oil or emulsion). The matrix was then coated in a wax diffusion barrier layer, which modulates the rate at which EOCs can be released from the matrix. In this case, the wax diffusion barrier layer also keeps the matrix and carrier from absorbing humidity from the environment, making the system less sensitive to humidity. Representative results are shown in Table 2. Table 2 also illustrated VP differences achieved by changing the matrix materials without wax.

TABLE 2
equilibrium vapor pressure of various matrix materials.

| Matrix Materials | Equilibrium Vapor Pressure (PPM) |
|---|---|
| pure C59 in porous sponge (cellulose) | 72 |
| pure C59 in wax-coated porous sponge (cellulose) | 48 |
| 4 w % C59 in natural oil in porous sponge | 7.7 |
| (cellulose) | |
| 4 w % C59 in natural oil in wax-coated porous | 4.4 |
| sponge (cellulose) | |
| 4 w % C59 in emulsion in porous sponge | 18.5 |
| (cellulose) | |
| 4 w % C59 in emulsion in wax-coated porous | 16 |
| sponge (cellulose) | |

Wax diffusion barrier layers can also modulate compound vapor pressure on ceramic-based matrix. EOCs were encapsulated in an emulsion carrier, applied to a cardstock substrate, and cured with a calcium carbonate curing agent creating a ceramic based matrix. The coated card was then coated with one or two layers of paraffin wax. Thicker wax diffusion barriers reduce the EOC release more than thinner barriers, as evidenced by decreasing equilibrium vapor pressure with increasing barrier layer thickness.

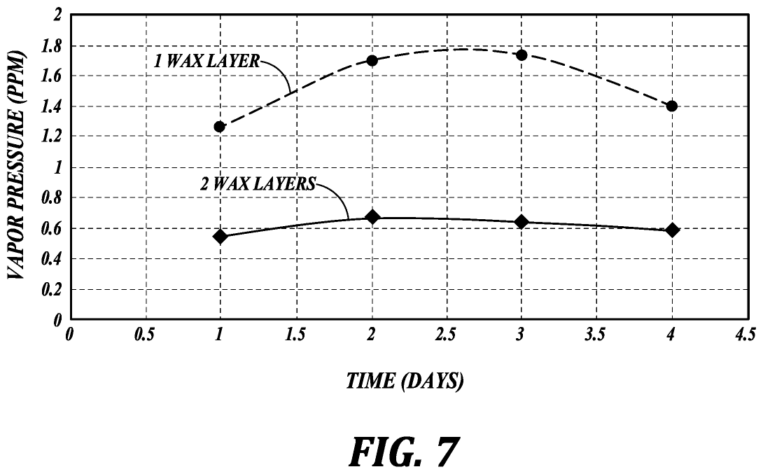

FIG. 7 is a graph showing vapor pressure of wax carriers (as shown in Table 3), in accordance with the present technology. On the horizontal axis is the time in days. On the vertical axis is the vapor pressure in PPM. The dashed line represents a single wax layer, while the solid line represents two wax layers, as shown in FIG. 2H.

TABLE 3
equilibrium vapor pressure of various matrix materials.

| Matrix Materials | Equilibrium Vapor Pressure (PPM) on day 1 |
|---|---|
| cured carrier on cardstock (no barrier layer) | 3.5 |
| cured carrier on cardstock, 1 wax layer | 1.3 |
| cured carrier on cardstock, 2 wax layers | 0.6 |

Applying a polymer diffusion barrier can also modulate compound vapor pressure and release rate. EOCs were encapsulated in an emulsion carrier, applied to a cardstock substrate, and cured with a calcium carbonate curing agent. The coated card was then laminated with different thicknesses of polypropylene (PP) film. Thicker films reduce the EOC release more than thinner films (Table 4).

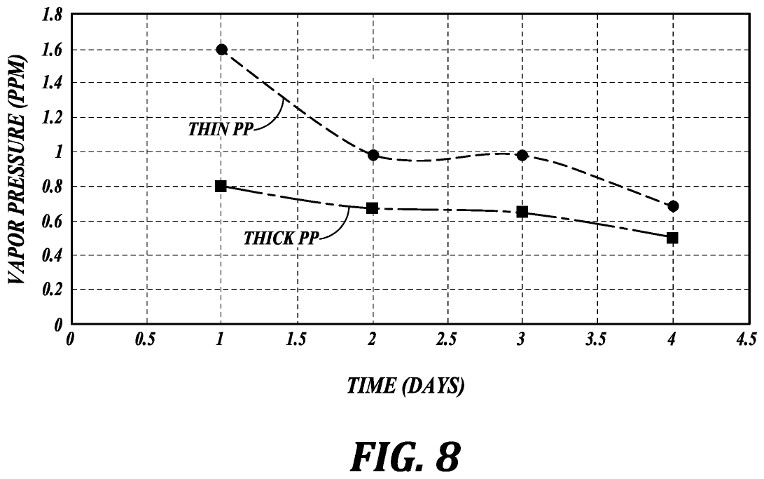

FIG. 8 is a graph showing vapor pressure of PP film carriers (as shown in Table 4), in accordance with the present technology. On the horizontal axis is the time in days. On the vertical axis is the vapor pressure in PPM. The dashed line with circular nodes represents a thin PP film, and the dashed line with square nodes represents a thick PP film.

TABLE 4
equilibrium vapor pressure of various matrix materials.

| Matrix Materials | Vapor Pressure (PPM) on day 1 |
|---|---|
| cured carrier on cardstock (no barrier layer) | 3.5 |
| cured carrier on cardstock, thin PP layer | 1.6 |
| cured carrier on cardstock, thick PP layer | 0.8 |

It was shown that modifying the surface area to volume ratio of a carrier matrix while keeping the composition constant can modify the release profile of active compounds without significantly changing the equilibrium vapor pressure of the composition. Granules with higher surface area release more compound per unit time (faster) while a solid slab of the same composition and same total volume releases the volatile compound more slowly over time. Table 5 shows the eventual equilibrium pressure in a closed jar being essentially the same as expected, independent of the physical configuration (slab vs granules). This is because the differences between the physical configurations here do not affect the equilibrium state, only the speed at which it is reached.

TABLE 5

| | Eq. VP (PPM) |
|---|---|
| 1 g Oleogel Granules | 2.6 |
| sachet | |
| 1 g Oleogel slab sachet | 2.7 |

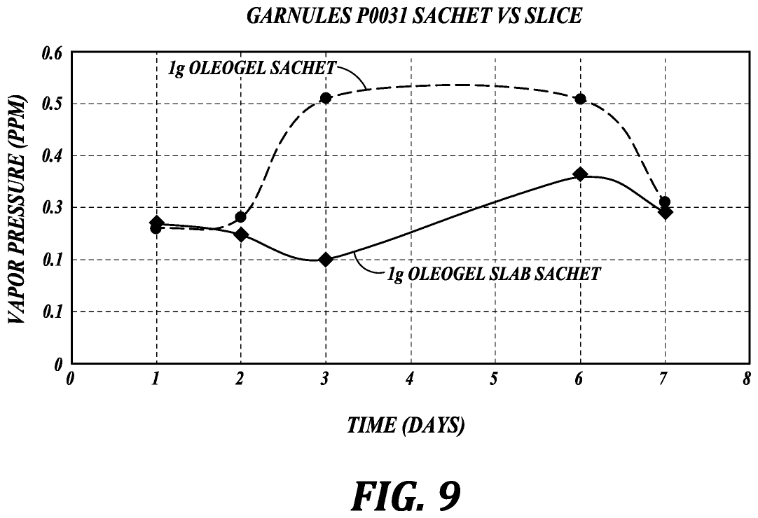

FIG. 9 shows the evolution over time of the vapor pressures measured in identically leaky containers, in accordance with the present technology. On the horizontal axis is the time in days. On the vertical axis is the vapor pressure in PPM. The solid line is a 1 g oleogel slab sachet, while the dashed line is a 1 g oleogel granules sachet.

In one case, a granules sachet contains a plurality of particles obtained by grinding a solid piece of carrier matrix containing active compounds into granules. As such it has high surface to volume ratio. In contrast, the slab sachet contains a single slab shaped block of compound, thereby having a smaller surface to volume ratio. Change of measured vapor pressure (VP) over time is a measure of release rate of the compounds. The high surface to volume ratio granules sachet releases its volatile compounds much faster than the slab sachet.

A series of simulation results were obtained, assuming realistic inputs. A molecular diffusivity of 1.4E-12 m\hat{ }2/s through beeswax was previously estimated. This is the value used in simulations, unless otherwise stated.

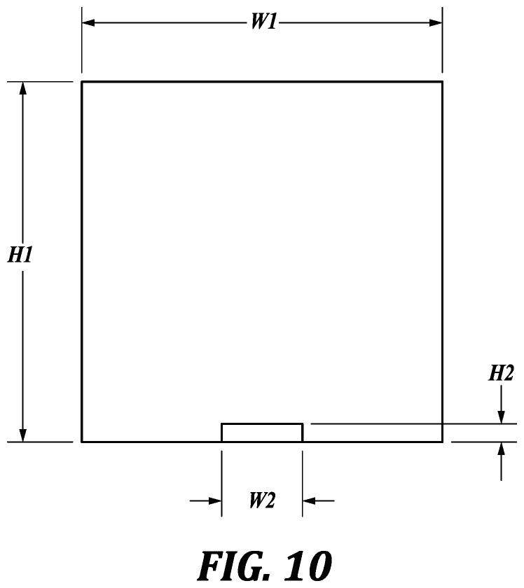

Unless otherwise stated, most situations modeled include a volatile compound source (compound source at the bottom of FIG. 10) in an empty, larger 10 cm by 10 cm box. The simulations explore concentrations in the box as well as concentration distribution in the compound sources as a function of various physical structure variations and material property variations.

FIG. 10 is an example geometry for a carrier used in the simulations, in accordance with the present technology. As shown, the box has a first width W1, and a first height H1. The volatile compound (or active compound) source has a second width W2 and a second height H2. In some embodiments, the large box is 10 by 10 centimeters, that is H1=10 cm and W1=10 cm. In some embodiments, the large box is the confined environment into which the volatile compound is released. In some embodiments, the compound source is the volatile compound source. In some embodiments, the compound source measures 2.24 cm by 0.45 cm, that is H2-0.45 cm and W2-2.24 cm.

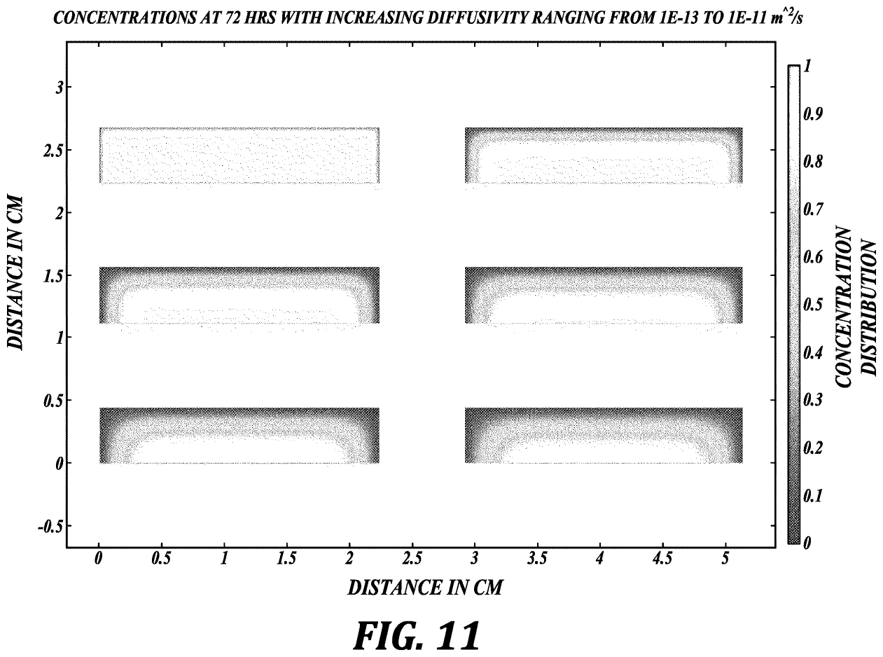

FIG. 11 shows concentration distribution of volatiles in solid rectangularly shaped carrier matrices, in accordance with the present technology. On the horizontal axis is distance in centimeters. On the left vertical axis is the distance in centimeters. On the right vertical axis is the concentration distribution. Each carrier shown has a different permeability to the volatiles at the same point in time (72 hours) after starting with an identical uniform concentration of 1 (in arbitrary units) at time zero. The higher the permeability of the carrier material to the volatile (in other words, higher the diffusivity of the volatile compound through the carrier material), the more pronounced is the concentration depletion toward the carrier's surface.

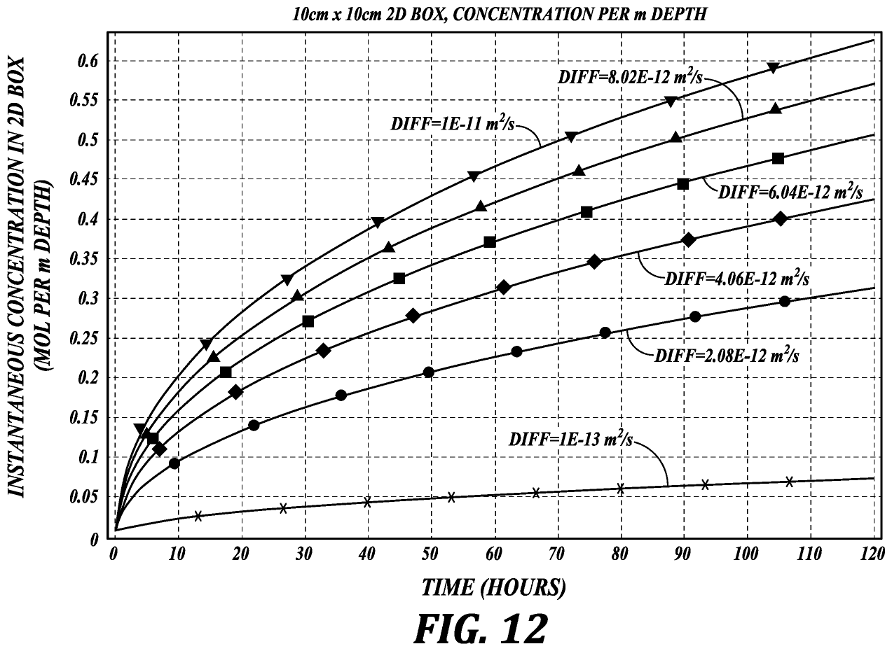

FIG. 12 is a graph of different release profiles from the matrices of FIG. 11, in accordance with the present technology. On the horizontal axis is the time in hours. On the vertical axis is the instantaneous concentration in a two-dimensional (2D) box in mol per meter (m) of depth. Variation of gas concentration in the box resulting from the release of the volatile from the carrier matrices is also shown. Results demonstrate the ability to increase the release rates and modulate the release profiles observed in the environment containing the carrier matrices by using materials with different diffusivities. A delivery matrix material with high diffusivity will release faster than one with low diffusivity. FIG. 12 shows concentrations in the box when the carriers shown in FIG. 11 are placed, one at a time (or independently) in an initially empty box. Accordingly, shown are six different scenarios showing the release observed is different based on the permeability of the carrier to the volatile compound(s).

Changes in aspect ratio dramatically change the release rate because it modifies the surface to Volume (S/V) ratio.

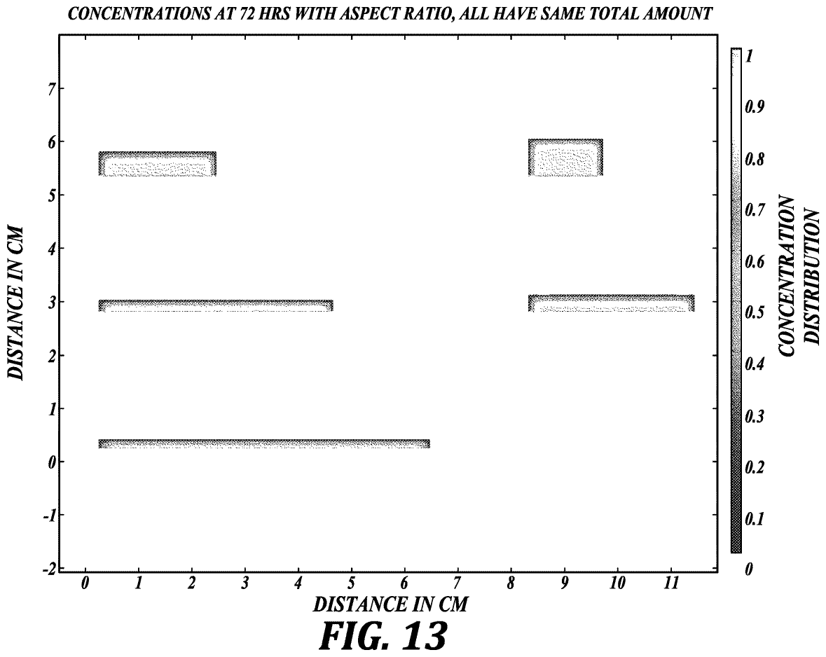

FIG. 13 shows concentration distribution of volatiles of different sized rectangular carriers, in accordance with the present technology. On the horizontal axis is distance in centimeters. On the left vertical axis is the distance in centimeters. On the right vertical axis is the concentration distribution. Each carrier has an equal permeability initially containing identical amounts of the same volatile compounds at 72 hours of evolution/release. They span a wide range of aspect ratios and S/V ratios.

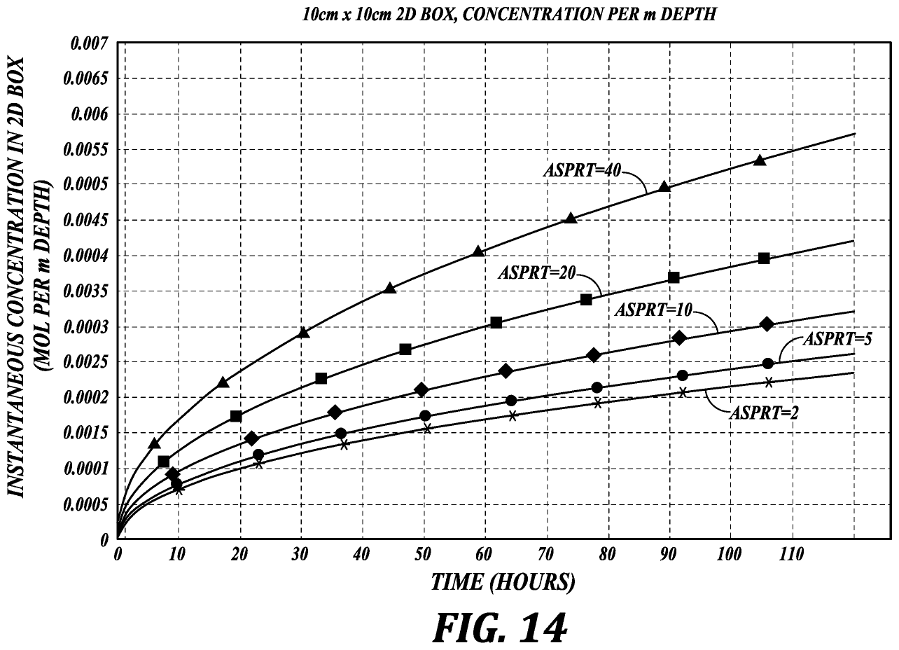

FIG. 14 is a graph of different release profiles from the differently sized matrices of FIG. 13, in accordance with the present technology. FIG. 14 shows significantly different release profiles observed in identical boxes containing these rectangular matrices. On the horizontal axis is the time in hours. On the vertical axis is the instantaneous concentration in a two-dimensional (2D) box in mol per meter (m) of depth. FIG. 14 shows what would be observed in an empty box when the carrier with different aspect ratios from FIG. 13 are simulated one at a time.

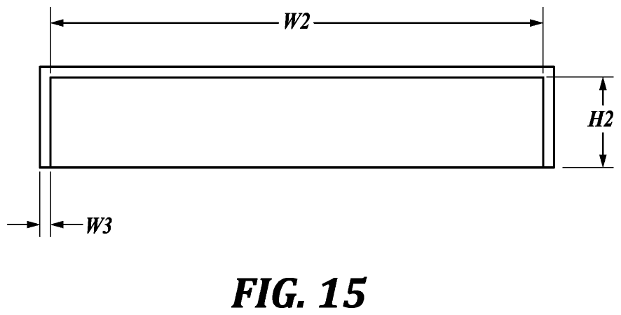

Also shown was the effect of an outer layer of different diffusivity on the observed release rates. FIG. 15 shows the construction of the carrier with multilayer construction, in accordance with the present technology. In some embodiments, the carrier includes a core having a second width W2 and a second height H2. In some embodiments, the core has an outer layer with a third width W3.

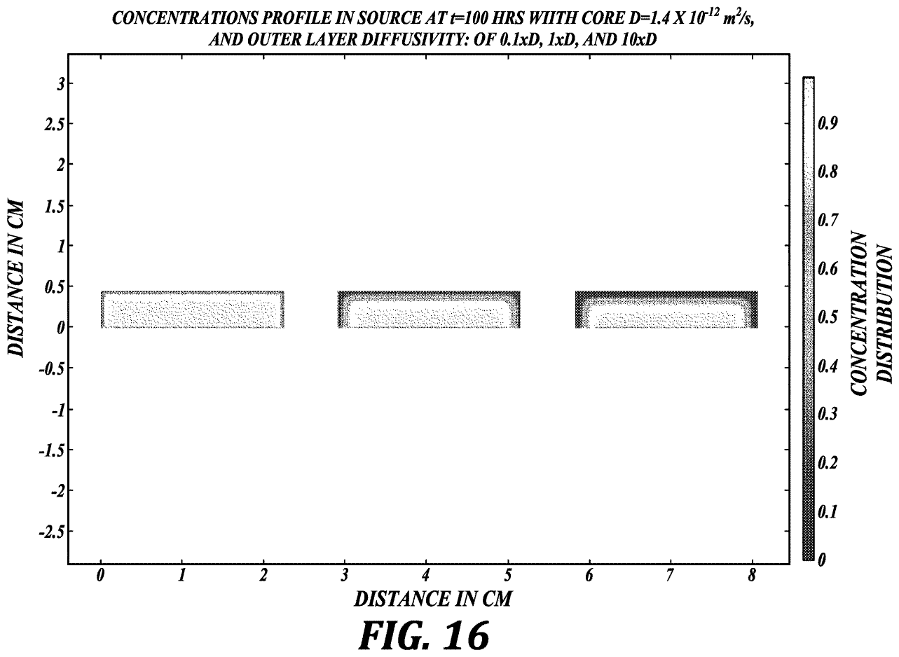

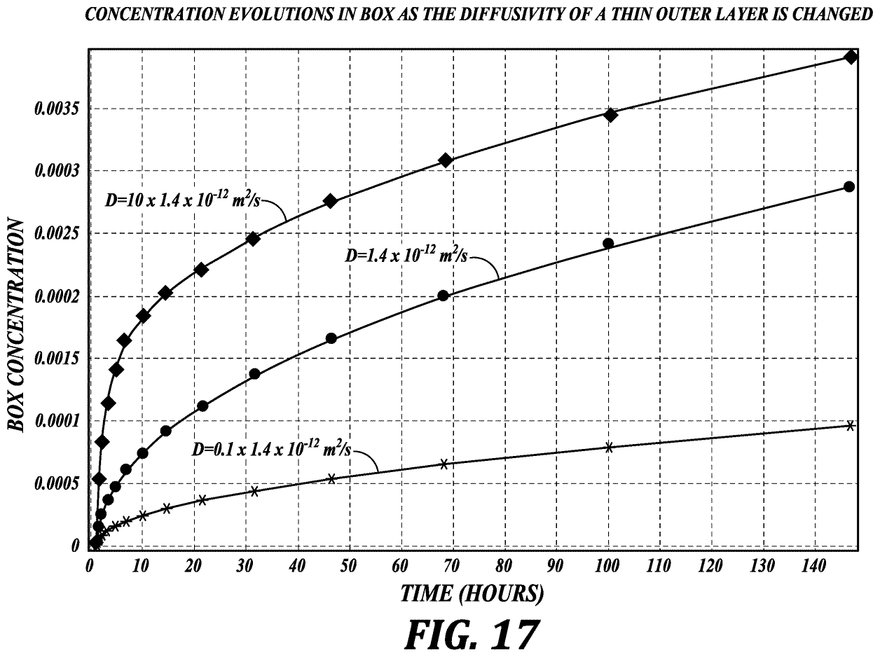

FIG. 16 shows carriers with outer layers of varying diffusivities, but having the same thickness, in accordance with the present technology. On the horizontal axis is distance in centimeters. On the left vertical axis is the distance in centimeters. On the right vertical axis is the concentration distribution. When the outer layer has high diffusivity, it releases its payload rapidly resulting in an initial burst and rapid increase in concentration in box (solid line with diamond nodes in FIG. 17). When the outer layer has much smaller diffusivity, it acts as a diffusion barrier to the core and slows down the entire release rate (solid line with “x” shaped nodes in FIG. 17). FIG. 16 shows the concentration distributions in the carriers at the end of 100 hours. Initially the compound is dispersed in both the core (2.24 cm by 0.45 cm box, that is W2=2.24 cm and H2=0.45 cm) and the margin (0.40 cm by 0.45 cm outer layer, where W3-0.40 cm) to be released into a big box around it (not shown). The diffusivity in the outer layer is made to vary 100 fold, from 0.1 times to 10 times the diffusivity in the core layer.

FIG. 17 is a graph of the different release profiles of the carriers of FIG. 16, in accordance with the present technology. On the horizontal axis is the time in hours. On the vertical axis is the instantaneous concentration in a two-dimensional (2D) box in mol per meter (m) of depth. The solid line with the diamond nodes represents a carrier having an outer layer with a highest diffusivity, the solid line with circular nodes represents a carrier having an outer layer with a medium diffusivity, and the solid line with the “x” shaped nodes represents a carrier with an outer layer having a low diffusivity.

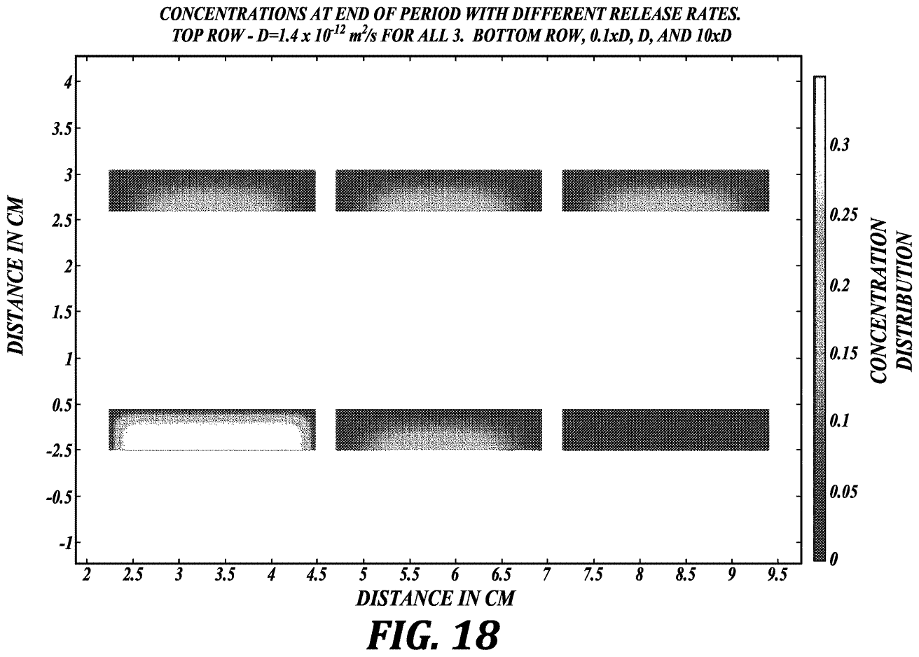

FIG. 18 shows concentration distribution of volatiles in solid, rectangularly shaped-carrier matrices, in accordance with the present technology. On the horizontal axis is distance in centimeters. On the left vertical axis is the distance in centimeters. On the right vertical axis is the concentration distribution. In one simulation, 3 sources (carriers) having equal permeability and shown on the top of FIG. 18 were simultaneously placed in the same box. The top row of FIG. 18 shows the sources which all have the same release rate (medium) at the end of a fixed duration. The bottom row of FIG. 18 shows the sources with three different permeabilities to the compounds (high-medium-low) at the end of the same fixed duration. In a second simulation, the bottom three carriers, having different permeabilities, were all placed into the box.

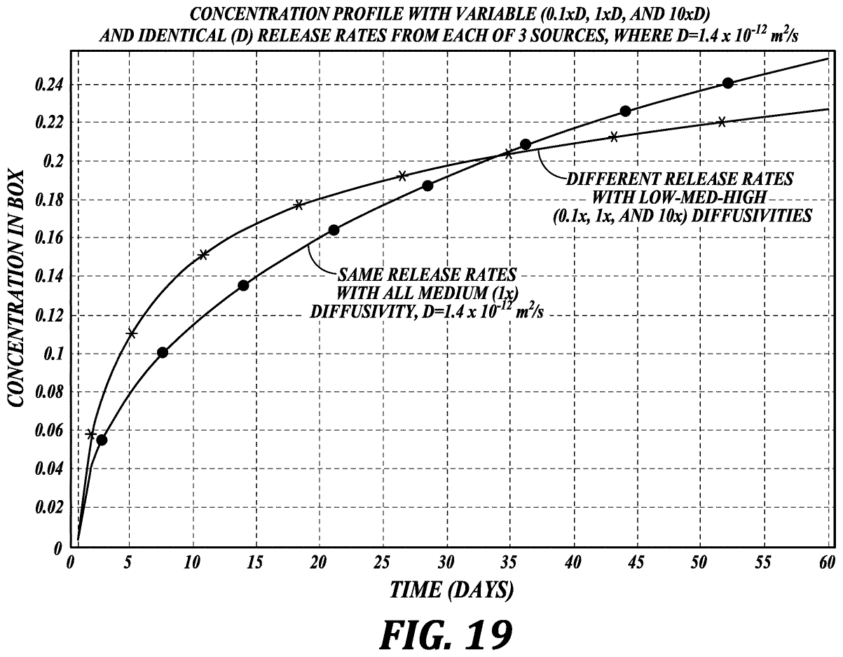

FIG. 19 is a graph of different release profiles from the matrices of FIG. 18, in accordance with the present technology. On the horizontal axis is the time in days. On the vertical axis is the concentration in the box. The line with circular nodes represents the top row of FIG. 18. The line with star shaped nodes represents the bottom row of FIG. 18. The fact that the 2nd case (bottom row of FIG. 18) consists of 3 sources with different release rates gives rise to a significantly modified release profile observed in the box containing them. Thus, including blends of carrier matrices with different permeabilities to the compounds can also be used to modulate the release profiles even when their physical shapes are similar. In particular, fast releasing embodiments can be included to quickly reach target concentrations in the environment, while slower releasing embodiments can be included to help maintain the required concentrations. This simulation demonstrates how different overall release profiles can be achieved by including multiple carriers with different permeabilities and intrinsic release rates. In this particular simulation intrinsic release rates of each carrier were modified through diffusivity/permeability. But as shown in other examples intrinsic release rates can also be affected by S/V ratio, physical patterning, aspect ratio etc. Thus, including different types of multiple carriers allows a wide range of net/overall release rates to be obtained.

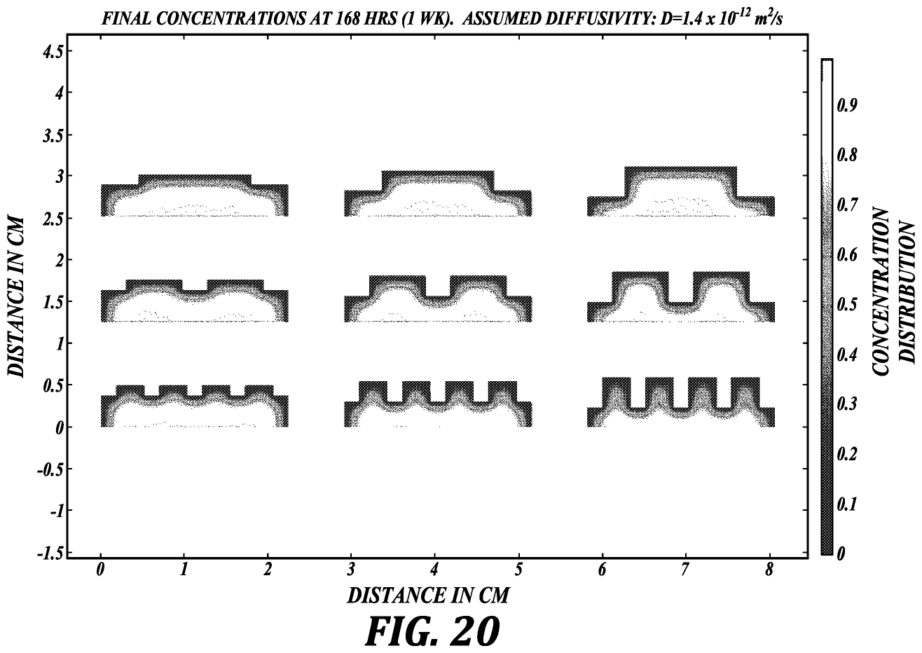

FIG. 20 shows concentration distribution of volatiles of different shapes, in accordance with the present technology. On the horizontal axis is the distance in centimeters. On the left vertical axis is the distance in centimeters. On the right vertical axis is the concentration distribution. The effect of different S/V ratios and diffusion path lengths by changing detailed shapes was also simulated. This effect is modeled by implementing ridges (corrugations) that lift above the base by different amounts. In all cases the total source amount was kept the same, and the cases only differ from one another in their geometries.

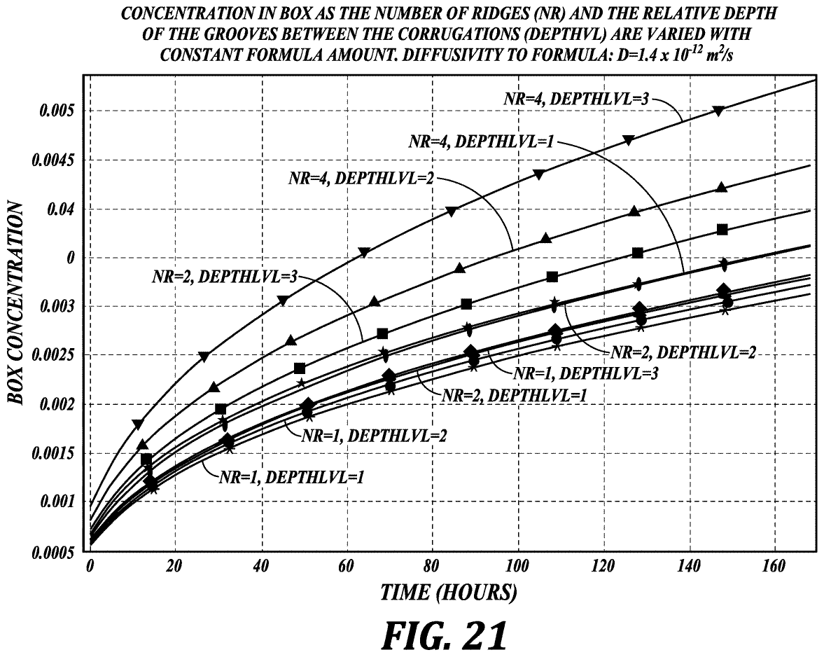

FIG. 21 is a graph of different release profiles in the differently shaped matrices of FIG. 20, in accordance with the present technology. On the horizontal axis is the time in hours. On the vertical axis is the concentration in the box. FIG. 21 shows resultant concentrations that would be observed in identical boxes containing each one of the sources shown in FIG. 20 one at a time. As is shown in FIG. 21, simply changing the physical topology which changes the S/V and effective diffusion paths results in different release profiles. This effect can also be used to tailor the topology and geometry of the source (carrier matrix) designs to achieve desired release profiles.

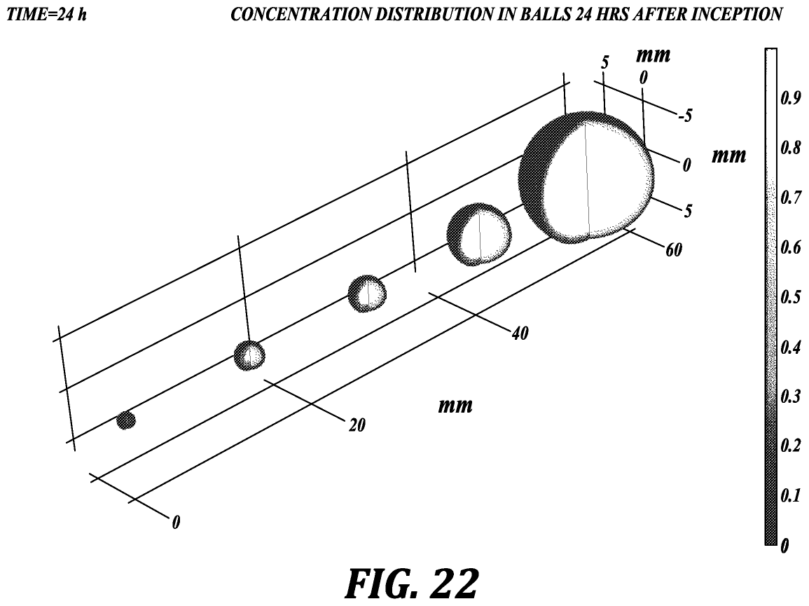

FIG. 22 shows concentration distribution from ball-shaped volatiles, in accordance with the present technology. On the horizontal axis is the distance in millimeters. On the left vertical axis is the distance in millimeters. On the right vertical axis is the concentration distribution. Affecting release rates by changing the overall S/V ratio by dividing one large round ball into more and more smaller balls was also simulated. In this simulation, the total volume of the ball shaped (spherical) sources (carrier matrices) and the total amount of compound contained in them are kept the same. Thus, in terms of the total amount of material and compound included, several small spheres could be equivalent to fewer larger spheres. The only difference arises from the differences in S/V ratios. A larger number of smaller diameter balls will release their volatile payload faster than fewer larger balls, even when the total ball volume (total amount of material included in the simulations) is the same.

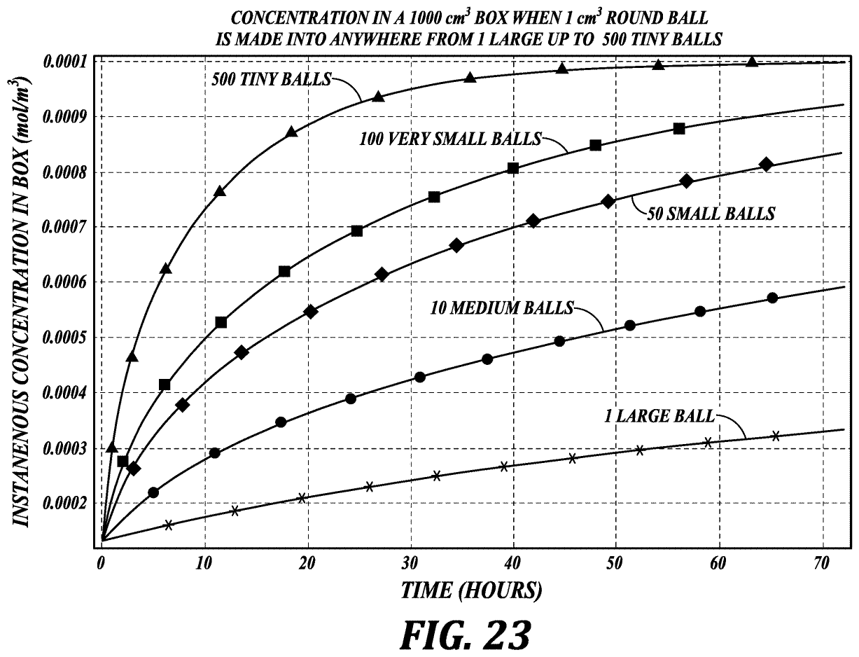

FIG. 23 is a graph of different release profiles of the ball-shaped volatiles of FIG. 22, in accordance with the present technology. On the horizontal axis is the time in hours. On the vertical axis is the instantaneous concentration in the box. The relative sizes of each ball as well as the concentration distribution within them after the same duration are shown in FIG. 23. Plotted is 500 tiny balls, 100 very small balls, 50 small balls, 10 medium balls, and 1 large ball, each having the same amount of compound within them. As shown, the smaller balls in larger numbers had higher diffusivity than the single large ball.

1. A transmission system for reducing a rate of decomposition of a perishable good, the system comprising:
one or more compositions, wherein the one or more compositions comprise at least one active compound; and
at least one carrier configured to support the one or more compositions, wherein the at least one carrier comprises:
a release rate altering mechanism, wherein the release rate altering mechanism is configured to modulate a release rate of the at least one active compound.

2. The system of claim 1, wherein the at least one active compound is selected from a group consisting of one or more volatile compound, one or more non-volatile compound, one or more plant immune-stimulatory compound, one or more ethylene actor compound, and combinations thereof.

3. The system of claim 1, wherein the release rate altering mechanism is one or more diffusion barriers or one or more peel-away layers.

5. The system of claim 3, wherein the one or more diffusion barriers is responsive to an environmental stimuli, wherein the environmental stimuli includes temperature, humidity, or a combination thereof.

6. The system of claim 1, wherein the release rate altering mechanism is a porosity of the at least one carrier, selected from macroscopic, mesoscopic, microscopic pores, or a combination thereof.

7. The system of claim 1, wherein the release rate altering mechanism is a shape of the at least one carrier, selected from a disc shaped form, a honeycomb form, a dimpled form, a ribbed form, a finned form, a sphere form, a cylindrical form, granules, irregularly shaped beads, shavings, powders, sheets, flakes, and combinations thereof.

8. The system of claim 7, wherein the at least one carrier has a plurality of surface to volume ratios.

9. The system of claim 8, wherein the at least one carrier is a plurality of carriers, and wherein each carrier of the plurality of carriers has a surface to volume ratio that is distinct from at least one other carrier.

10. The system of claim 8, wherein the at least one carrier is a flattened, patterned disc having a plurality of ridges, each having a distinct ridge width and pitch.

11. The system of claim 1, wherein the carrier is selected from a group consisting of water, paraffin, petroleum waxes, petroleum oils, natural waxes, beeswax, natural and modified natural oils such as canola oil, grapeseed oil, hydrogenated soy oil, etc., resins or rosins, synthetic polymer, natural polymer or gum such ass, alginate, starch, carrageenan, agar, shellac, pectin, chitin, inulin, lignin, hyaluronic acid, chitosan, collagen, keratin, xanthan gum, gum Arabic, mastic, Guar gum, etc., ceramic, modified cellulose such as, methyl cellulose, ethyl cellulose, and hydroxypropyl methylcellulose, surfactants, mesoporous silica nanoparticles, microporous alumina, anodized aluminum, activated carbon, zeolites, clays, metal carboxylates, inorganic compounds, and combinations thereof.

12. The system of claim 2, wherein the volatile compound is selected from a group consisting of trans-2-hexenal, trans-2-octenal, trans-2-nonenal, trans-2-decenal, trans-2-dodecenal, cuminaldehyde, citronellal, thymol, perillaldehyde, carvacrol, citral, carvone, pulegone, eugenol, bornyl acetate, 1-octanol, terpinen-4-ol, linalool, trans-anethole, trans-cinnamaldehyde, ethyl octanoate, ethyl nonanoate, ethyl decanoate, methyl octanoate, methyl nonanoate, methyl decanoate, fenchol, borneol, camphor, methyl eugenol, menthol, methyl salicylate, methyl anthranilate, phenylethyl acetate, phenylacetic acid, cinnamic acetate, gamma-octalactone, gamma-decalactone, eucalyptol, geranium oil, lavender oil, thyme oil, clove oil, (−)-bornyl acetate, (−)-terpinen-4-ol, (+)-carvone, (+)-citronellal, (R)-(+)-citronellal, (S)-(−)-citronellal, (R)-(+)-pulegone, thymol, 4-isopropylbenzaldehyde (cuminaldehyde), 4-allylanisole, cis-3,7-dimethyl-2,6-octadien-1-ol, citronellol, methyl trans cinnamate, myrcene, ocimene, terpineol, 1-methyl-3-methoxy-4-isopropylbenzene, menthol, menthone, isomenthone, vanillin, geranyl formate, palmitic acid, (S)-(−)-perillaldehyde, nootkatone, hinokitiol, d-limonene, s-limonene, -cymene, nerolidol, 3-decen-2-one, and combinations thereof.

13. The system of claim 2, wherein the non-volatile compound is selected from a group consisting of curcumin, chitosan, phytoalexins, phytoanticipin, one or more preservative, Vitamin E, Vitamin A, Vitamin C, tocopherol, catechins, anthocyanins, polyphenols, butylated hydroxytoluene (BHT), butylated hydroxyanisole (BHA), and beta carotene.

14. The system of claim 2, wherein the plant immune-stimulatory compound is selected from a group consisting of pinene, camphene, terpinene, terpineol, chitosan, phytoalexins, phytoanticipin, methyl salicylate, ethyl salicylate, methyl cinnamate, methyl jasmonate, jasmonic acid, cinnamic acid, salicylic acid, ethylene, β-aminobutyric acid, methyl salicylic acid, ethyl salicylic acid, methyl cinnamic acid, fructans, ethylene, and harpin protein.

15. The system of claim 2, wherein the ethylene actor compound is selected from a group consisting of activated carbon, norbornadiene, resveratrol, sodium permanganate, potassium permanganate, vanillin, 1-methylcyclopropene, and combinations thereof.

16. The system of claim 1, wherein the carrier further comprises one or more additive compound.

17. The system of claim 16, wherein the one or more additive compound is selected from a group consisting of one or more macrocycle, surfactants, one or more antioxidant, urea, one or more polymers, and combinations thereof.

18. The system of claim 17, wherein the one or more antioxidant is selected from a group consisting of Vitamin A, Vitamin C, Vitamin E, beta carotene, tocopherol, butylated hydroxytoluene (BHT), butylated hydroxyanisole (BHA), and combinations thereof.

21. A method for extending a life of a perishable good, comprising:
placing one or more transmission systems of claim 1 within an area that includes the perishable good.

22. A transmission system for reducing decomposition of a perishable good, the system comprising:
a plurality of vesicles;
one or more compositions, positioned within the plurality of vesicles, wherein the one or more compositions comprise at least one active compound, and at least one non-active compound; and
at least one carrier configured to support the one or more compositions, wherein the at least one carrier comprises:
a release rate altering mechanism, wherein the release rate altering mechanism is configured to modulate a release rate of the at least one active compound.

32. A transmission system for reducing decomposition of a perishable good, the system comprising:
one or more compositions, wherein the one or more compositions comprise at least one active compound, at least one non-active compound, and a release rate altering mechanism, wherein the release rate altering mechanism is configured to modulate a release rate of the at least one active compound; and
at least one carrier configured to support the one or more compositions.
